(19) United States
(12) Patent Application Publication
(10) Pub. No.: US 2026/0323348 A1
(43) Pub. Date: Oct. 15, 2026

(54) L1 AND L3 INTER-UE CROSS LINK INTERFERENCE CONFIGURATIONS

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Jae Ho RYU, San Diego, CA (US)

(21) Appl. No.: 19/177,366

(22) Filed: Apr. 11, 2025

(51) Int. Cl. H04W 24/10; H04W 72/232

(52) U.S. Cl. CPC H04W 24/10; H04W 72/232

(57) ABSTRACT

A UE receives a first cross-link interference (CLI) measurement configuration; and receives a second CLI measurement configuration, where one of the first CLI measurement configuration or the second CLI measurement configuration is a layer 1 (L1) CLI measurement configuration and one of the first CLI measurement configuration or the second CLI measurement configuration is a layer 3 (L3) CLI measurement configuration. The UE measures UE-to-UE CLI measurements based on at least one of a rule or UE capability and at least one of an L1 CLI measurement resource indicated in the L1 CLI measurement configuration or an L3 CLI measurement resource indicated in the L3 CLI measurement configuration.

### TECHNICAL FIELD

The present disclosure relates generally to communication systems, and more particularly, to wireless communication that includes measurement of cross-link interference (CLI).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. Among other examples, 5G New Radio (NR) is a telecommunication standard. 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies, such as 6G, among other examples. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). As an example, the apparatus includes memory and at least one processor coupled to the memory and configured to receive a first cross-link interference (CLI) measurement configuration; receive a second CLI measurement configuration, wherein one of the first CLI measurement configuration or the second CLI measurement configuration is a layer 1 (L1) CLI measurement configuration and one of the first CLI measurement configuration or the second CLI measurement configuration is a layer 3 (L3) CLI measurement configuration; and measure UE-to-UE CLI measurements based on at least one of a rule or UE capability and at least one of an L1 CLI measurement resource indicated in the L1 CLI measurement configuration or an L3 CLI measurement resource indicated in the L3 CLI measurement configuration.

In an aspect of the disclosure, a method, a computer-readable medium, and an apparatus are provided for wireless communication at a network node. As an example, the apparatus includes memory and at least one processor coupled to the memory and configured to provide a first cross-link interference (CLI) measurement configuration for a user equipment (UE); provide a second CLI measurement configuration for the UE, wherein one of the first CLI measurement configuration or the second CLI measurement configuration is a layer 1 (L1) CLI measurement configuration and one of the first CLI measurement configuration or the second CLI measurement configuration is a layer 3 (L3) CLI measurement configuration; and receive a report of UE-to-UE CLI measurements based on at least one of a rule or UE capability and at least one of an L1 CLI measurement resource indicated in the L1 CLI measurement configuration or an L3 CLI measurement resource indicated in the L3 CLI measurement configuration.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 illustrates an example of full-duplex resources, in accordance with various aspects of the present disclosure.

FIG. 5 illustrates example aspects of full duplex communication at a network node, such as a base station, in accordance with various aspects of the present disclosure.

FIG. 6 illustrates example aspects of potential interreference based on full duplex communication, in accordance with various aspects of the present disclosure.

FIG. 7 is a communication flow between a UE and a network node showing example aspects of configurations of different types of inter-UE (e.g., UE-to-UE) CLI measurement and/or report configurations, in accordance with various aspects of the present disclosure.

FIG. 8 is a communication flow between a UE and a network node showing example aspects of configurations of different types of inter-UE (e.g., UE-to-UE) CLI measurement and/or report configurations, in accordance with various aspects of the present disclosure.

FIG. 9 is a communication flow between a UE and a network node showing example aspects of configurations of different types of inter-UE (e.g., UE-to-UE) CLI measurement and/or report configurations, in accordance with various aspects of the present disclosure.

FIG. 10A and FIG. 10B illustrate example communication flows between components of a network node that configure different types of inter-UE (e.g., UE-to-UE) CLI measurement and/or report configurations, in accordance with various aspects of the present disclosure.

FIG. 11A is a communication flow between a UE and a network node showing example aspects of configurations of different types of inter-UE (e.g., UE-to-UE) CLI measurement and/or report configurations, in accordance with various aspects of the present disclosure.

FIG. 11B illustrates an example communication flow between components of a network node that configure different types of inter-UE (e.g., UE-to-UE) CLI measurement and/or report configurations, in accordance with various aspects of the present disclosure.

FIG. 12A and FIG. 12B illustrate example communication flows between components of a network node that configure different types of inter-UE (e.g., UE-to-UE) CLI measurement and/or report configurations, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a diagram illustrating an example of a hardware implementation for an example apparatus and/or network entity, in accordance with various aspects of the present disclosure.

FIG. 16 is a diagram illustrating an example of a hardware implementation for an example network entity, in accordance with various aspects of the present disclosure.

### DETAILED DESCRIPTION

A UE may receive a configuration for L3 inter-UE (e.g., UE-to-UE) CLI measurement and/or reporting. As used herein the terms “inter-UE CLI” and “UE-to-UE CLI” may be used interchangeably. In some aspects, a UE may be configured for L1 inter-UE CLI measurement and/or reporting. A UE may or may not support simultaneous configuration for both L1 and L3 inter-UE CLI measurement. The support or lack of support may be based a rule defined in a wireless communication standard or a capability of the UE, for example. Aspects presented herein enable a network node to determine whether to configure a UE for L1 and/or L3 inter-UE CLI measurement.

For example, aspects presented herein enable a network node to configure one or more types of inter-UE CLI measurement resources/reports, e.g., based on one or more of a rule or a UE capability. Some aspects provide for reduced latency in changing between L1 and L3 inter-UE CLI measurement resources. Some aspects provide for simultaneous configuration for L1 and L3 inter-UE CLI measurement resources, which can reduce latency for the UE to provide CLI measurement information to the network, which enables the network to more quickly act to improve communication with the UE. As an example, aspects may allow for a UE to be configured with L1 and L3 inter-UE CLI measurement resources that occur in a same slot.

In some examples, a UE may not expect to be simultaneously configured for both L1 and L3 inter-UE CLI measurement. In some aspects, the UE may not expect to have both L1 and L3 inter-UE CLI measurement configurations active at a same time. For example, a rule may indicate that a UE is not to be simultaneously configured with both L1 and L3 inter-UE CLI measurement resources or that both L1 and L3 inter-UE CLI measurement resources are active for the UE at a same time. The network may release one type of L1 or L3 inter-UE CLI measurement configuration prior to configuring the UE with the other type of L1 or L3 inter-UE CLI measurement configuration. The network may deactivate one type of L1 or L3 inter-UE CLI measurement configuration prior to activating the UE with the other type of L1 or L3 inter-UE CLI measurement configuration. The configuration or activation of one type of inter-UE CLI measurement configuration may release or deactivate the other type of L1 or L3 inter-UE CLI measurement configuration, e.g., based on a rule, capability, or other expectation that the UE will not be simultaneously configured with both L1 and L3 inter-UE CLI measurement resources.

In some examples, a UE may support a UE capability associated with simultaneous L1 and L3 inter-UE CLI measurement configurations. The UE may provide information to the network informing the network of the UE's support for one or more capability associated with simultaneous L1 and L3 inter-UE CLI measurement configurations. Such capability information may indicate maximum numbers of total configured resources that the UE supports, e.g., per component carrier (CC), per bandwidth part (BWP), cross CCs, and/or in a slot. The total number may be shared between configured L1 and L3 CLI measurement resources. The total number may include both type #1 and type #2 L1 inter-UE CLI measurement resources. In some aspects, the UE may send a CLI report based on a first type of CLI measurement configuration (e.g., L1 inter-UE CLI report) that includes measurements based on the other type of CLI measurement resources (e.g., L3 inter-UE CLI measurement resources).

In some aspects, a distributed unit (DU) and centralized unit (CU), e.g., as components of a base station, may exchange information (e.g., via F1AP) about the L1 or L3 CLI measurement configurations that are configured, activated, and/or deactivated for the UE. This enables the DU and CU to make more informed decisions when determining whether to configure a type of inter-UE CLI measurement configuration for a UE. This helps to avoid configuring a UE with more configurations, e.g., of CLI measurement resources, than the UE supports.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, 6G systems, or other communication systems, may be arranged in multiple manners with various components or constituent parts. As an example, in a wireless communication system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

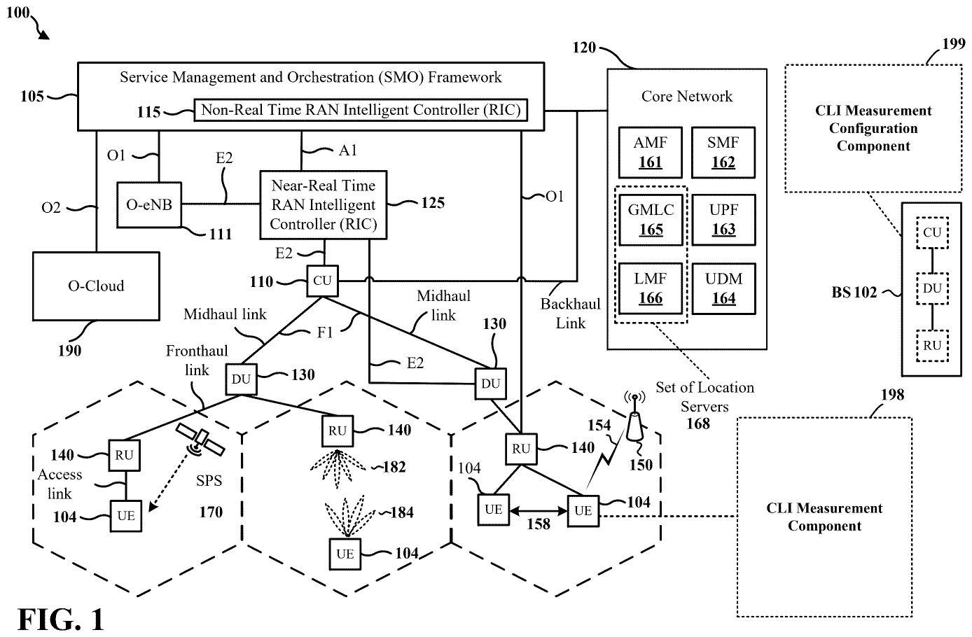

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. Two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. An operating band has been identified for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a CLI measurement component 198 that may be configured to receive a first cross-link interference (CLI) measurement configuration; receive a second CLI measurement configuration, wherein one of the first CLI measurement configuration or the second CLI measurement configuration is a layer 1 (L1) CLI measurement configuration and one of the first CLI measurement configuration or the second CLI measurement configuration is a layer 3 (L3) CLI measurement configuration; and measure UE-to-UE CLI measurements based on at least one of a rule or UE capability and at least one of an L1 CLI measurement resource indicated in the L1 CLI measurement configuration or an L3 CLI measurement resource indicated in the L3 CLI measurement configuration.

In certain aspects, the base station 102 may have a CLI measurement configuration component 199 that may be configured to provide a first cross-link interference (CLI) measurement configuration for a user equipment (UE); provide a second CLI measurement configuration for the UE, wherein one of the first CLI measurement configuration or the second CLI measurement configuration is a layer 1 (L1) CLI measurement configuration and one of the first CLI measurement configuration or the second CLI measurement configuration is a layer 3 (L3) CLI measurement configuration; and receive a report of UE-to-UE CLI measurements based on at least one of a rule or UE capability and at least one of an L1 CLI measurement resource indicated in the L1 CLI measurement configuration or an L3 CLI measurement resource indicated in the L3 CLI measurement configuration.

Although some of the following description may give examples based on 5G NR to illustrate concepts relating to wireless communication, the concepts described herein may be applicable to other similar areas, such as LTE, LTE-A, CDMA, GSM, 6G, and other wireless technologies.

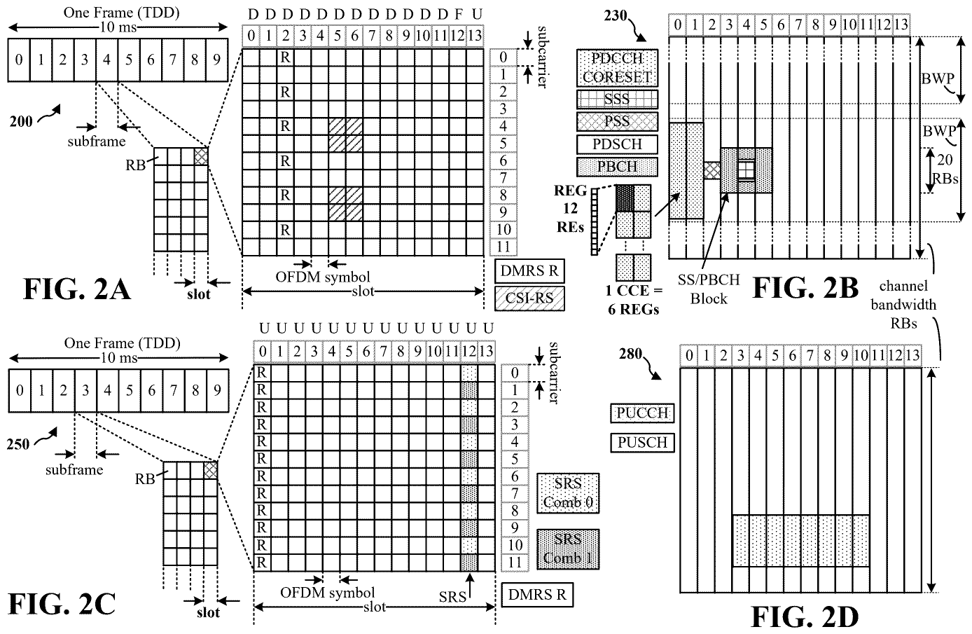

FIG. 2A is a diagram 200 illustrating an example of a first subframe within a frame structure. FIG. 2B is a diagram 230 illustrating an example of DL channels within a subframe. FIG. 2C is a diagram 250 illustrating an example of a second subframe within a frame structure. FIG. 2D is a diagram 280 illustrating an example of UL channels within a subframe. The examples in FIGS. 2A-2D show example aspects of a frame structure based on 5G NR to illustrate the concept of a frame structure and wireless communication based on a frame structure. Various aspects described in connection with FIGS. 2A-2D may also be used in connection with other wireless communication technologies, such as 6G among other examples. The frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

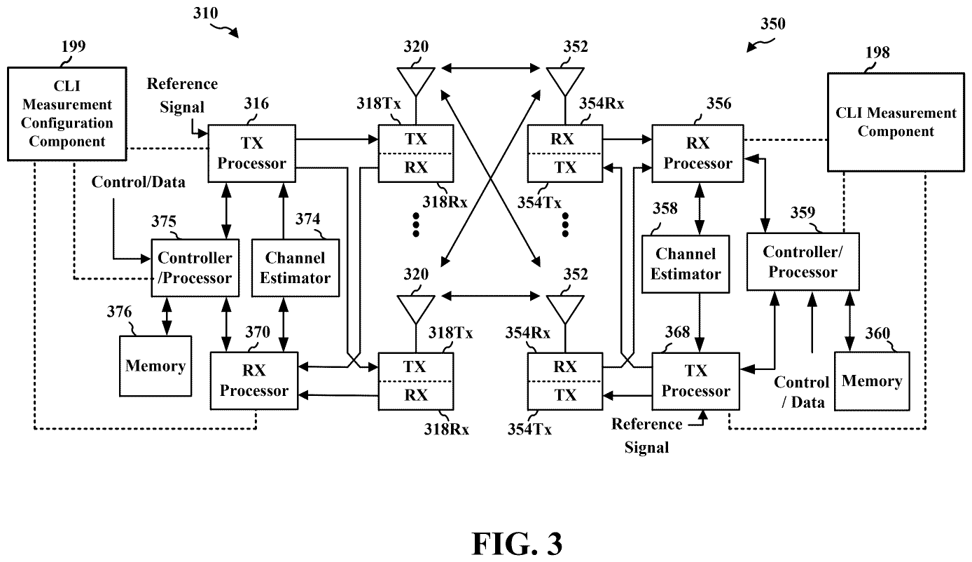

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the CLI measurement component 198 of FIG. 1.

At least one of the TX processor 316, the RX processor 370, and the controller/processor 375 may be configured to perform aspects in connection with the CLI measurement configuration component 199 of FIG. 1.

Full-duplex communication supports transmission and reception of information over a same frequency band in a manner that overlaps in time. In this manner, spectral efficiency may be improved with respect to the spectral efficiency of half-duplex communication, which supports transmission or reception of information in one direction at a time without overlapping uplink and downlink communication. Due to the simultaneous Tx/Rx nature of full-duplex communication, a UE or a base station may experience interference, including self-interference and/or interference from other devices, such as transmissions from a second UE and/or a second base station. Such interference can impact the quality of the communication, or even lead to a loss of information

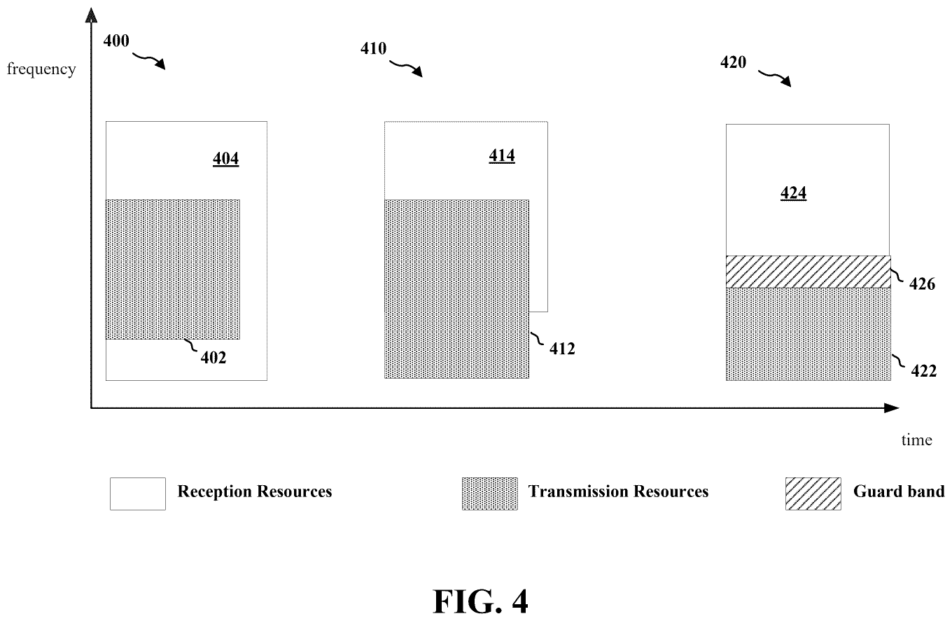

Full duplex communication may be in a same frequency band. The uplink and downlink communication may be in different frequency sub-bands, in the same frequency sub-band, or in partially overlapping frequency sub-bands. FIG. 4 illustrates a first example 400 and a second example 410 of in-band full-duplex (IBFD) resources and a third example 420 of SBFD resources. In IBFD, wireless signals may be transmitted and received that overlap in both time and frequency. As shown in the first example 400, a time and a frequency allocation of transmission resources 402 may fully overlap with a time and a frequency allocation of reception resources 404. In the second example 410, a time and a frequency allocation of transmission resources 412 may partially overlap with a time and a frequency of allocation of reception resources 414. In some aspects, the transmission resources may correspond to uplink resources, and the reception resources may correspond to downlink resources. In some aspects, the transmission resources may correspond to downlink resources, and the reception resources may correspond to uplink resources

In contrast to the IBFD shown at 400 and 410, the SBFD resources shown at 420 overlap in time using different frequencies. In some aspects, the transmission resources 422 are separated from the reception resources 424 by a guard band 426. The guard band includes frequency resources provided between the transmission resources 422 and the reception resources 424. Separating the transmission frequency resources and the reception frequency resources with a frequency guard band may help to reduce interference. Transmission resources and reception resources that are immediately adjacent to each other may be considered as having a guard band width of zero. As an output signal from a wireless device may extend outside the transmission resources, the guard band may reduce interference experienced by the wireless device. SBFD may also be referred to as flexible duplex, in some aspects.

A time division duplex (TDD) configuration (e.g., which may be referred to as a TDD-UL-DL configuration) may indicate a pattern of time resources (e.g., one or more symbols or one or more slots) including downlink resources, uplink resources, or flexible resources. In some aspects, a slot format having a frequency band that is used for both uplink and downlink transmissions may be referred to as a D+U slot, a D+U symbol, an SBFD slot, or an SBFD symbol, for example. Downlink and uplink transmissions may occur in overlapping frequency resources, such as shown in 404 and 406 (e.g., in-band full duplex resources) or may occur in adjacent or slightly separated frequency resources, such as shown in 420 (e.g., SBFD resources). A half-duplex device may either transmit in the uplink band or receive in the downlink band of a SBFD time resource (e.g., SBFD slot or SBFD symbol). A full-duplex device may transmit in the uplink band and receive in the downlink band of an SBFD time resource (e.g., SBFD slot or SBFD symbol). A D+U slot may include downlink only symbols, uplink only symbols, and full-duplex symbols.

A time division duplex (TDD) configuration (e.g., which may be referred to as a TDD-UL-DL configuration) may indicate a pattern of time resources (e.g., one or more symbols or one or more slots) including downlink resources, uplink resources, or flexible resources. In some aspects, a slot format may be referred to as a “D+U” slot or an SBFD slot when the slot has a frequency band that is used for both uplink and downlink transmissions. The downlink and uplink transmissions may occur in overlapping frequency resources, such as shown in 404 and 406 (e.g., in-band full duplex resources) or may occur in adjacent or slightly separated frequency resources, such as shown in 420 (e.g., SBFD resources). In a particular D+U symbol, a half-duplex device may either transmit in the uplink band or receive in the downlink band. In a particular D+U symbol, a full-duplex device may transmit in the uplink band and receive in the downlink band, e.g., in the same symbol or in the same slot. A D+U slot may include downlink only symbols, uplink only symbols, and full-duplex symbols.

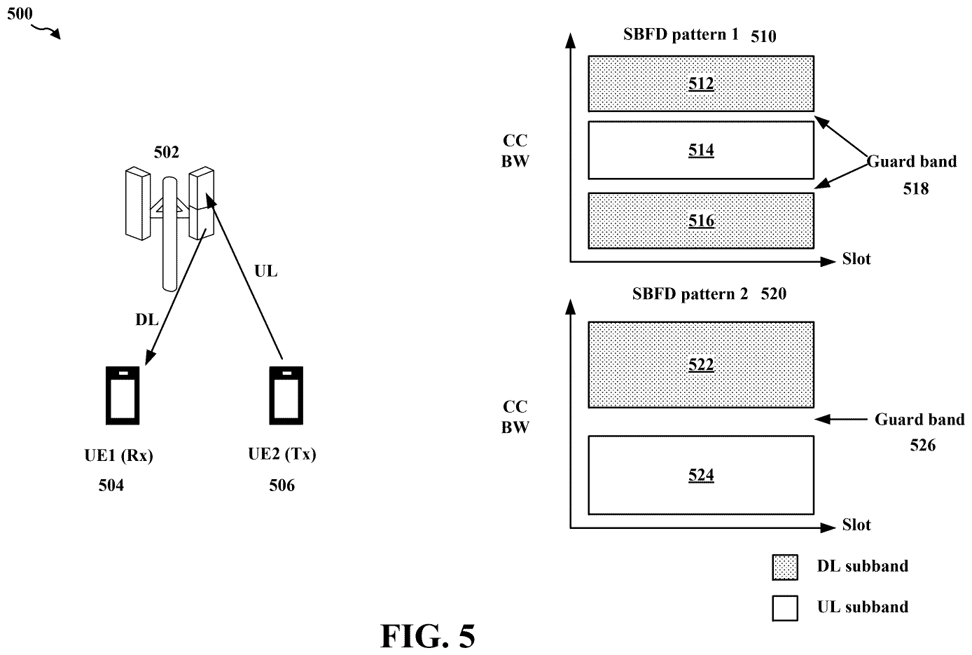

At the network side, SBFD operation allows the network (e.g., a base station) to simultaneously serve UEs based on both DL and UL communication on corresponding sub-bands. FIG. 5 is a diagram 500 illustrating an example of the network SBFD operation. As shown in FIG. 5, the network node (e.g., base station 502) may operate in the FD mode and simultaneously serve one UE (UE1 504) on an DL and another UE (UE2 506) on an UL. The DL and UL communication may occur simultaneously (e.g., overlapping at least partially in time) within the corresponding sub-bands of the same symbol or slot. For example, in FIG. 5, the first example SBFD pattern 510 includes D+U+D configuration, which includes DL sub-bands 512 and 516 and an UL sub-band 514. FIG. 5 illustrates an example in which a portion of an antenna panel at the base station 502 may transmit the downlink communication, and a portion of the antenna panel at the base station 502 may receive the uplink communication. The second example SBFD pattern 520 shows an example D+U configuration, which includes a DL sub-band 522 and an UL sub-band 524. To minimize interference between DL and UL sub-bands, one or more guard bands (e.g., guard bands 518, 526) may be provided that include a number of resource blocks (RBs) between the DL and UL sub-bands.

SBFD operation allows simultaneous use of downlink and uplink resources on a sub-band basis. The SBFD operation may increase the UL duty cycle, resulting in reduced latency. For example, SBFD operation allows for the transmission of the UL signal in the UL sub-band (e.g., 512 and 516) in DL slots or flexible slots. On the other hand, SBFD operation also allows the reception of DL signals in DL sub-band in UL slots. These adaptations help to reduce latency. Additionally, SBFD contributes to an improvement in UL coverage, e.g., by enabling UL transmissions at the same time as DL communication (e.g., simultaneous UL transmission via UL sub-band 524 and DL transmission via DL sub-band 522). Furthermore, SBFD operation enhances the system's capacity, resource utilization, and overall spectrum efficiency, and enables dynamic and flexible UL/DL resource adaptation according to UL and DL traffic, thereby optimizing the network performance.

In some aspects, the resources, such as symbols or slots, may be configured as flexible or DL/‘D’ (e.g., in a TDD-UL-DL configuration such as TDD-UL-DL-ConfigCommon) for the SBFD operation. For SBFD operation in a symbol configured as flexible or D (e.g., in TDD-UL-DL-ConfigCommon), several resource and communication arrangements may be made to accommodate the SBFD operation for SBFD-aware UEs (e.g., UEs that support capabilities associated with knowing about the network's operation in the SBFD mode). A SBFD aware UE may be SBFD-capable (e.g., support SBFD operation of the UE) or may not be SBFD-capable.

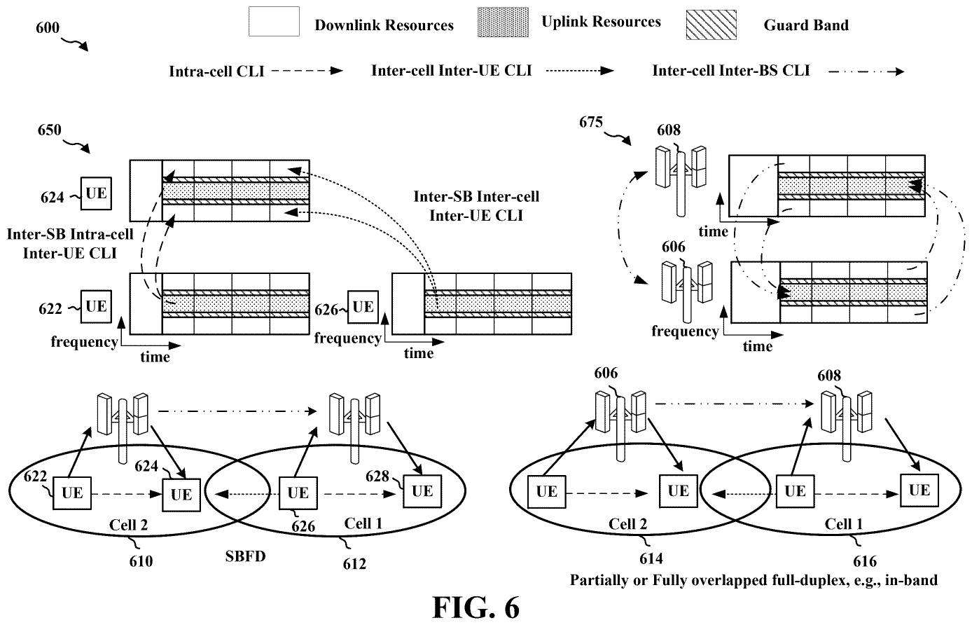

FIG. 6 is a diagram 600 that illustrates examples of different types of potential cross-link interference (CLI) based on full-duplex communication, including inter-cell and intra-cell interference based on SBFD communication at cells 610 and 612 and inter-cell and intra-cell interference based on partially or fully overlapped FD communication (e.g., in-band full-duplex communication) at cells 614 and 616. For example, the base station 606 and the base station 608 may transmit and receive on overlapping resources, such as described in connection with the example 400 and 410 in FIG. 4. The time and frequency resource diagram 650 showing that the uplink transmissions from UE 622 in the cell 610 may cause inter-sub-band (inter-SB) intra-cell inter-UE CLI to the downlink resources of the UE 624. Similarly, the uplink transmissions of the UE 626 in the cell 612 may cause inter-SB inter-cell inter-UE CLI to the downlink resources of the UE 624. The time and frequency resource diagram 675 shows that the downlink transmissions from the base station 606 may cause in-band inter-cell inter-BS (e.g., inter-gNB) CLI to the uplink resources of the base station 608. Similarly, the downlink transmissions from the base station 608 may cause in-band inter-cell inter-BS CLI to the uplink resources of the base station 606. In some aspects, the transmission and reception from the base stations and the UEs may be based on directional beams, e.g., as described in connection with 182 and 184 in FIG. 1

In order to improve CLI handling, e.g., for inter-base station CLI, it can be helpful to exchange information about semi-static cell-specific SBFD time and frequency location configuration, measurement resource configuration (e.g., such as SSB and/or periodic NZP CSI-RS), strongest downlink beam information, and/or CLI-mitigation requests. As an example, network nodes may exchange information to assist with CLI avoidance and/or mitigation. In some aspects, uplink resource muting for PUSCH can be used, e.g., to mitigate CLI. An indication and/or determination of uplink resource muting for PUSCH transmissions may be based on a semi-static configuration. As an example, a comb-2 pattern may be used for DFT-S-OFDM or CP-OFDM in each allocated PRB and up to 2 symbols in time domain. In some aspects, PUSCH resource mapping, e.g., rate-matching can be performed around the muted REs. UCI resources may be determined in symbols with muted REs. There may be conditions on uplink resource muting. For example, uplink resource muting may apply for UEs in an RRC connected mode, e.g., and not for UEs that are not in an RRC connected mode. Uplink resource muting may not apply for some uplink transmissions, such as a random access Msg A PUSCH transmission and/or random access Msg 3 PUSCH transmission. In some aspects, a UE may assume that the UL resource muting pattern does not overlap with UL DMRS or PT-RS in the same symbol. In some aspects, power boosting may be assumed, or performed, for REs in a symbol with UL resource muting. PUSCH transmit power does not change across symbols. The use of a mitigation technique, such as uplink resource muting, may be subject to (e.g., occur based on a condition of) UE support for a UE capability associated with the information exchange and/or mitigation technique.

To address inter-UE CLI (which may also be referred to as UE-to-UE CLI), UEs may measure CLI and report CLI measurements to a network node. As an example, L1 based UE-to-UE CLI measurement and reporting may be configured based on a CSI framework. CLI measurement resources (e.g., time and frequency resources for measurement of inter-UE CLI) may be configured as periodic resources (e.g., that occur in a periodic manner without a triggering condition), semi-persistent resources (e.g., which may occur regularly for a period of time) and/or aperiodic resources (e.g., based on an occurrence of a condition or trigger). The CLI measurement resources may include a resource set. As an example, the CLI measurement resources may include SRS-RSRP resources or CLI-RSSI resources. Measurement resources for SRS-RSRP can be based on legacy RS patterns, in some aspects. In some aspects, network nodes can exchange SRS configuration information. The CLI measurement resources may be configured, or determined, based on a QCL assumption, e.g., such as QCL type D (e.g., spatial assumption) relationship to a signal such as a reference signal. In addition to receiving a configuration of CLI measurement resources from a network node, a UE may also receive a configuration for CLI measurement reporting. In some aspects, the CLI measurement reporting may be aperiodic, e.g., with transmission of a report based on an occurrence of a condition and/or a trigger. In some aspects, the CLI measurement reporting may be periodic and/or semi-persistent, e.g., with the UE transmitting periodic CLI measurement reports. In some aspects report quantities may be provided for the CLI measurement report, e.g., such as L1-SRS-RSRP, L1-CLI-RSSI and/or measurement resource indices. The CLI measurement reporting may include wideband reporting and/or UCI bits generation. In some aspects, priority rules may be applied for multiple CSI reporting. In some aspects, a CSI processing unit (CPI), a CPU occupation rule, and/or timeline for L1 beam reporting can be used for L1 UE-to-UE CLI measurement and reporting. In some aspects, there may be CLI measurement accuracy requirements.

A UE may be configured with L3 UE-to-UE CLI measurement and reporting. For wireless communication that may include the use of SBFD resources, reduced latency and quicker measurements for UE-to-UE CLI can be provided through the use of L1 UE-to-UE CLI measurement and reporting. As there are L1 and L3 CLI measurement resources and reporting that are possible to be configured for a UE, there may be conditions that affect whether a UE is configured with, or has activated, either an L1 or an L3 CLI measurement/reporting configuration (e.g., one type of CLI measurement/report configuration at a time) or can be simultaneously configured with, or have activated, both an L1 and an L3 CLI measurement/report configuration.

As an example, aspects presented herein provide rules about simultaneously configured L1 and L3 inter-UE CLI resources. In some aspects, a UE may not expect to be simultaneously configured with both L3 and L1 UE-to-UE CLI measurement resources. In some aspects, a UE may support simultaneously configuration for both L3 and L1 UE-to-UE CLI measurement/report.

As an example, a UE may not expect to be simultaneously configured with both L3 UE-to-UE measurement resources and L1 UE-to-UE CLI measurement resources. Similarly, a UE may not expect to be simultaneously configured with both an L3 UE-to-UE report configuration and an L1 UE-to-UE CLI report configuration. In some examples, the UE can be either configured with L3 or L1 UE-to-UE CLI measurement resources, but only one type of CLI configuration at a time. In some examples, the UE can be either have L3 or L1 UE-to-UE CLI measurement resources activated, but only one type of CLI configuration is activated at a time. For example, a network node may configure or activate one type of CLI configuration (e.g., either L3 or L1 UE-to-UE CLI measurement resources) at a time for the UE.

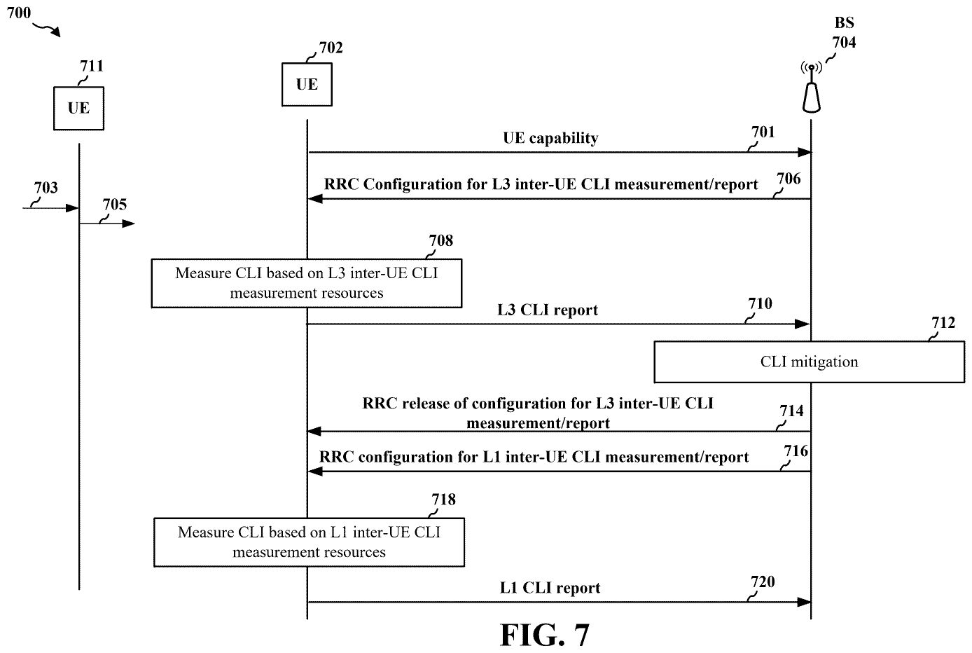

FIG. 7 illustrates an example communication flow 700 in which a UE 702 measures UE-to-UE (e.g., inter-UE) CLI based on a single type of CLI configuration. At 706, the UE 702 receives a first configuration (e.g., an RRC configuration) of a first type of CLI configuration (e.g., for L3 inter-UE CLI measurement resources and/or report) from the network node 704. The network node 704 may correspond to a base station in aggregation or one or more components of a disaggregated base station, for example. The measurement resources may be periodic, semi-persistent, and/or aperiodic. The configured report may be periodic, semi-persistent, and/or aperiodic.

At 708, the UE 702 measures CLI based on the first type (e.g., L3) CLI measurement resources configured for the UE. For example, the UE 702 may measure CLI from a downlink signal 703 for another UE 711 and/or an uplink signal 705 transmitted by the UE 711. The UE 711 may be served by the same cell (e.g., and same network node 704) as the UE 702 (e.g., such as shown for the UE 622 and 624) or may be served by a different cell and/or different network node (e.g., as shown by the UE 24 and the UE 626). The UE 702 transmits a report 710 (e.g., L3 inter-UE CLI report) to the network node 704 based on the CLI measurements performed at 708. As an example the UE 702 may send the report based on an L3 inter-UE CLI report configuration (e.g., 706). The network node 704 may use the CLI report to determine whether to mitigate the CLI experienced by the UE 702, at 712. The network node 704 may adjust communication with the UE 702 or with another UE in response to reported CLI. The network node 704 may coordinate with another network node in response to the reported CLI.

As shown at 714, the network node 714 may later release the first type of configuration, at 714. For example, the network node may transmit an RRC message indicating that the L3 inter-UE CLI configuration from 706 is released. At 716, the network node may transmit a configuration (e.g., an RRC configuration) of a second type of inter-UE CLI configuration, e.g., with L1 inter-UE CLI measurement resources and/or an L1 inter-UE CLI report configuration. In some aspects, the RRC release, at 714, and the RRC configuration, at 716, may be included in a single message. In other examples, the RRC release, at 714, and the RRC configuration, at 716, may be transmitted in separate messages. As an example, the L1 inter-UE CLI measurement resources may be periodic, semi-persistent, and/or aperiodic, such as based on an SRS-RSRP resource or a CLI-RSSI resource. The configured report may be periodic, semi-persistent, and/or aperiodic. The configuration may include report quantities based on one or more of an L1-SRS-RSRP, an L1-CLI-RSSI, and/or measurement resource indices. At 718, the UE 702 measures CLI based on the second type (e.g., L1) CLI measurement resources configured for the UE. As described in connection with 703 and 705, the UE 702 may measure CLI, at 718, based on signals transmitted to or by the UE 711. The UE 702 transmits a report 720 (e.g., and L1 inter-UE CLI report) to the network node 704 based on the CLI measurements performed at 718.

For example, if the UE 702 is configured with periodic L3 UE-to-UE CLI measurement resources, later due to a potential CLI issue that may cause a significant amount of CLI to the UE 702, the network node 704 may intend to trigger the interfered UE (e.g., UE 702) to measure CLI in aperiodic L1 UE-to-UE CLI measurement resources. However, if there is a rule (e.g., defined in a wireless standard or specification) that indicates that a UE is not to be simultaneously configured with both L3 and L1 inter-UE CLI measurement/report configurations, the network node first transmits a release of the L3 UE-to-UE CLI measurement resources by RRC, such as at 714, (which may add latency of at least 10 ms or more). In some aspects, the rule may indicate that a UE does not expect to be simultaneously configured with both L3 and L1 inter-UE CLI measurement/report configurations. The network node 704 then configures the L1 aperiodic UE-to-UE CLI measurement resources, at 716.

When considering the amount of L1 UE-to-UE CLI measurement CLI-RSSI resources, both type #1 and type #2 UE-to-UE CLI measurement resources may be considered. A type #1 CLI-RSSI measurement resource is configured within a DL subband or a UL subband, for example. A type #2 CLI-RSSI measurement resource is configured across multiple (e.g., two) DL subbands. In some aspects, there may be a maximum number of resources that can be configured. In some aspects, the UE 702 may indicate the maximum number of resources that the UE supports, e.g., in UE capability signalling to the network node 704, as shown at 701. Using the information received from the UE 702, the network node 704 may then configure measurement resources, e.g., at 706 and 716, based on the number of resources supported by the UE. For example, if supported, the UE 702 may indicate the maximum # of total configured UE-to-UE CLI measurement resources per CC supported by the UE. If supported, the UE 702 may indicate the maximum # of total configured UE-to-UE CLI measurement resources per BWP supported by the UE. If supported, the UE 702 may indicate the maximum # of total configured UE-to-UE CLI measurement resources cross CCs supported by the UE. If supported, the UE 702 may indicate the maximum # of total configured UE-to-UE CLI measurement resources supported by the UE in a slot.

In order to reduce latency to release one type of CLI measurement resource and to configure another type of CLI measurement resource, in some aspects, the network may indicate and activation/deactivation of a previously configured L3 or L1 inter-UE CLI measurement or report configuration. In such examples, the UE may not expect, or may not support, more than one type of inter-UE CLI measurement or report configurations to be simultaneously active. In some aspects, the network node may use MAC-CE signaling to activate and/or deactivate, e.g., the L3 periodic UE-to-UE CLI measurement resources or L1 UE-to-UE CLI measurement resources. L3 periodic UE-to-UE CLI measurement resources are just an example, and the activation/deactivation concept can be generalized to activate and/or deactivate any type of existing/configured CLI measurement resources. In some aspects, the network node may use DCI, e.g. non-scheduling DCI signaling, to activate and/or deactivate the L3 UE-to-UE CLI measurement resources or L1 UE-to-UE CLI measurement resources.

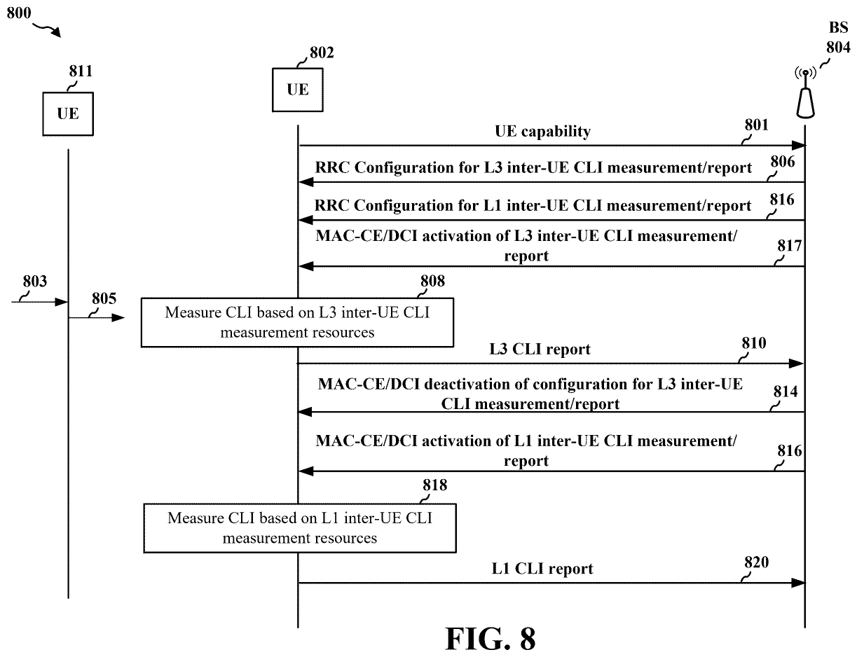

FIG. 8 illustrates an example communication flow 800 between a UE 802 and a network node 804. Aspects performed by the network node 804 may be performed by a base station in aggregation or by one or more components of a disaggregated base station, for example. The UE 802 receives a configuration of L3 inter-UE CLI measurement resources and/or an L3 inter-UE CLI report configuration, at 806, and receives a configuration of an L1 inter-UE CLI measurement resources and/or an L1 inter-UE CLI report configuration. The configurations at 806 and 816 may include any of the aspects described in connection with the configurations 706 and 716 in FIG. 7, for example. Although illustrated with separate lines, the configurations may be provided to the UE 702 together or in separate messages/transmissions. Based on a rule (e.g., defined in a wireless standard) or based on a capability supported by the UE 702 (e.g., which the UE may indicate at 801), the UE 802 may not expect to have an L3 and L1 inter-UE CLI measurement/report configuration simultaneously activated for the UE. The network node 804 may signal an activation, at 817, of one of the types of inter-UE CLI measurement or report configurations to the UE 802. For example, at 816, the network node 804 transmits a MAC-CE or DCI that indicates an activation of the L3 inter-UE CLI measurement/report configuration (e.g., from 806). The UE measures CLI (e.g., based on downlink 803 or uplink 805 signaling for the UE 811) at 808, based on the activated type of inter-UE CLI measurement resources (e.g., L3). At 810, the UE transmits a report (e.g., an L3 CLI report) based on the activated type of inter-UE CLI measurement resources or report.

At 814, the network node 804 indicates a deactivation of the activated inter-UE CLI measurement resources/report. For example, the network node 804 may transmit a MAC-CE and/or a DCI (e.g., a non-scheduling DCI) that includes an indication for the UE 802 to deactivate the L3 inter-UE CLI measurement report configuration. As shown at 816, the network node 804 may transmit a MAC-CE/DCI that indicates an activation of the other type of CLI measurement resource/report (e.g., the L1 inter-UE CLI measurement report or configuration that was configured at 816). In some aspects, the deactivation of the first type of inter-UE CLI measurement resource and the activation of the second type of inter-UE CLI measurement resource may be indicated in a separate MAC-CE or a separate DCI. In some aspects, the deactivation of the first type of inter-UE CLI measurement resource and the activation of the second type of inter-UE CLI measurement resource may be indicated in a single MAC-CE or a single DCI. In some aspects, the activation of the second type of inter-UE CLI measurement/report configuration may correspond to the deactivation indication for the first type of inter-UE CLI measurement/report configuration. For example, if a rule indicates that the UE is not to have more than one active configuration, the activation of one type of inter-UE CLI measurement/report configuration may cause the UE to deactivate, or consider as deactivated, the other type of inter-UE CLI measurement/report configuration. The UE 802 measures the CLI based on the activated inter-UE CLI measurement resource (e.g. L1 inter-UE CLI measurement resource), at 818 and transmits a CLI report (e.g., L1 inter-UE CLI report) at 820. The report 810 and 820 may include any of the aspects described in connection with the reports in FIG. 7, for example.

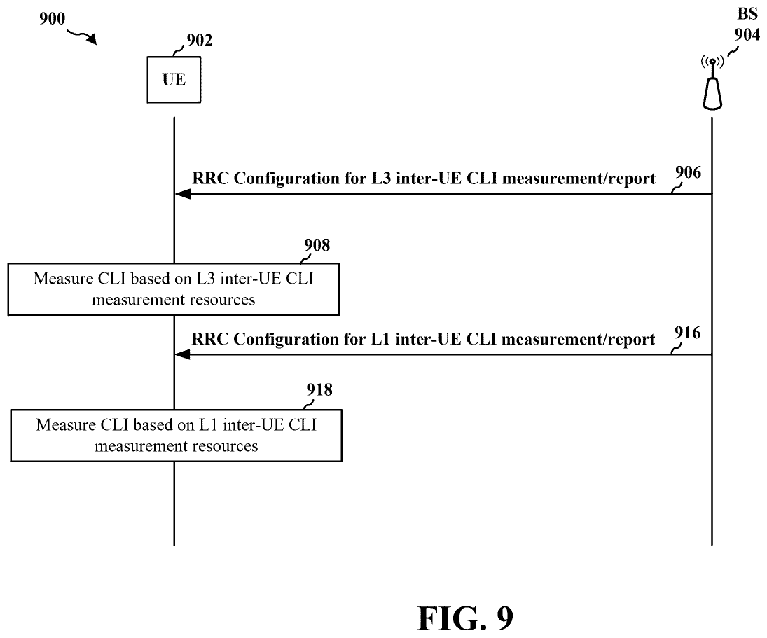

In some aspects, latency may be reduced for switching to the other type of CLI measurement resource configuration more quickly based on a rule (e.g., defined in a wireless standard) for UE behavior that indicates once a UE receives the other type of UE-to-UE CLI measurement resources, e.g., the previously received type of UE-to-UE (e.g., inter-UE) CLI measurement resources are released. As an example, in response to reception of the L1 aperiodic UE-to-UE CLI measurement resources, the UE may release the previously configured UE-to-UE CLI measurement resources, e.g., periodic L3 UE-to-UE CLI measurement resources. For example, the UE may overwrite (or override) periodic L3 UE-to-UE CLI measurement resources based on newly configured L1 aperiodic UE-to-UE CLI measurement resources. FIG. 9 illustrates an example communication flow 900 between a UE 902 and a network node 904 that includes the release of a previous type of inter-UE CLI measurement/report configuration in response to reception of a different type of inter-UE CLI measurement/report configuration. Aspects performed by the network node 904 may be performed by a base station in aggregation or by one or more components of a disaggregated base station, for example.

As an example, at 906 the UE 902 may receive an RRC configuration for an L3 inter-UE CLI measurement resource or report. The UE may measure CLI based on the configured resources (e.g., for L3), at 908. At 916, the UE 902 may receive an RRC configuration for L1 inter-UE CLI measurement resources or report. In response to the L1 configuration, the UE 902 releases the RRC configuration for an L3 inter-UE CLI measurement resource or report, from 906, and measures, at 918, CLI based on the RRC configuration for an L1 inter-UE CLI measurement resource or report. The release may be based on a rule (e.g., defined in a wireless standard) that a UE is not to be configured simultaneously with L1 and L3 CLI measurement/report configurations. The release may be based on a UE capability, e.g., if the UE does not support simultaneous configurations for L1 and L3 CLI measurement/report. The communication flow 900 may include further aspects, e.g., described in connection with FIG. 7. In contrast to the communication flow in FIG. 7, in FIG. 9, the L3 inter-UE CLI measurement configuration is released without a separate release indication or message.

Although the examples in FIGS. 7, 8, and 9 show the UE receiving the L3 CLI measurement/report configuration or activation that is then released and the L1 CLI measurement/report configuration received or activated, this is merely an example to illustrate the concept. The aspects may similarly be applied be applied for the L1 CLI measurement/report configuration that is then deactivated/released and an L2 CLI measurement/report configuration that is configured/activated.

As L3 UE-to-UE CLI measurement resources may be configured by a CU (e.g., a first network node), and L1 UE-to-UE CLI measurement resources may be configured by a DU (e.g., a second network node), the network nodes may exchange information to avoid configuring the UE with simultaneous L1 and L3 inter-UE CLI measurement resources. As described in connection with FIGS. 7, 8, and 9, the aspects may be performed by one or more components of a network node, e.g., such as a CU, DU, and RU, e.g., as described in connection with FIG. 1.

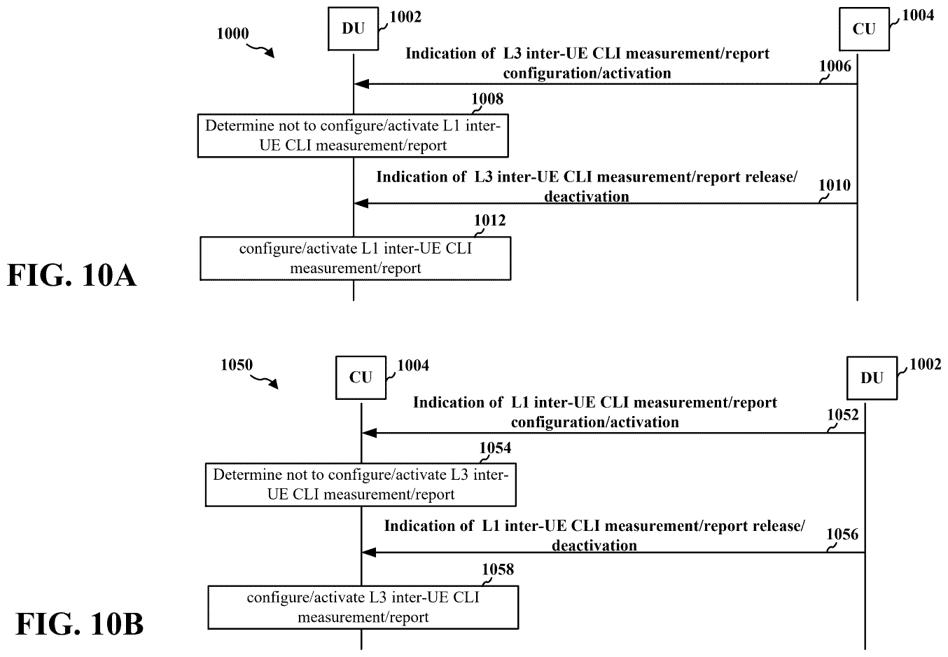

In some aspects, a CU can signal, to the DU, the release of a configuration of L3 UE-to-UE CLI measurement resources for a UE, which may help the DU to be aware that the DU can configure L1 UE-to-UE CLI measurement resources for the UE. The signaling between the CU and DU is over F1AP backhaul signaling. FIG. 10A illustrates an example communication flow 1000 between a DU 1002 and a CU 1004. As shown at 1010, the CU 1004 may send an indication to the DU 1002 about the release of an L3 inter-UE CLI measurement or report configuration for a UE (e.g., such as the UE 702, 802, or 902). Based on the information received from the CU 1004, informing the DU 1002 that the L3 CLI measurement/report configuration is or will be released, the DU 1002 may determine to configure (or that it is possible to configurat) an L1 inter-UE CLI measurement/report configuration for the UE, at 1012. Additionally, or alternatively, the CU may signal an indication to the DU 1002 about a deactivation of the L3 CLI measurement/report configuration. In response, the DU 1002 may determine to activate (or that it is possible to activate) an L1 CLI measurement/report configuration.

In some aspects, the DU 1002 can signal, to the CU 1004, the release of, or deactivation of, a configuration of L1 UE-to-UE CLI measurement resources, e.g., as shown at 1056 in the communication flow 1050 in FIG. 10B. The CU 1004 can determine to configure L3 UE-to-UE CLI measurement resources, at 1058. The signaling between the CU and DU may be over F1AP backhaul signaling, for example.

In some aspects, the CU 1004 can signal the configuration, or an indication of a configuration, of L3 UE-to-UE CLI measurement resources to the DU, as shown at 1006 in FIG. 10A. This information from the CU 1004 enables the DU 1002 to determine whether to configure L1 UE-to-UE CLI measurement resources, as shown at 1008. The signaling between the CU and DU may be over F1AP backhaul signaling, for example.

In some aspects, the DU 1002 can signal the configuration, or an indication of a configuration, of L1 UE-to-UE CLI measurement resources to the CU 1004, as shown at 1052. This information enables the CU 1004 can decide whether to configure L3 UE-to-UE CLI measurement resources for the UE, e.g., as shown at 1054. The signaling between the CU and DU may be over F1AP backhaul signaling, for example.

In some aspects, a UE can support simultaneous configuration with both L3 and L1 UE-to-UE CLI measurement resources. The UE may transmit information to the network node to indicate whether the UE supports one or more UE capabilities associated with simultaneous configuration with both L3 and L1 UE-to-UE CLI measurement resources. In some aspects, the UE capability signaling may indicate whether or not the UE supports simultaneous configuration with both L3 and L1 UE-to-UE CLI measurement resources. In some aspects, the UE capability signaling may indicate further capabilities relating to simultaneous configuration with both L3 and L1 UE-to-UE CLI measurement resources.

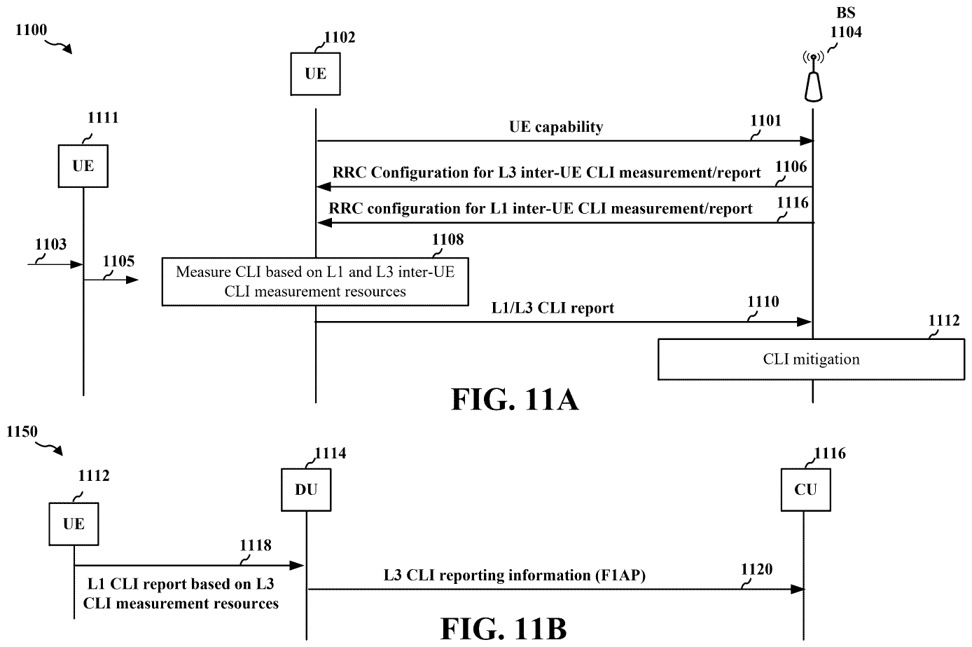

FIG. 11A illustrates an example communication flow 1100 between a UE 1102 and a network node 1104. The aspects performed by the network node 1104 may be performed by a base station in aggregation or may be performed by one or more components of a base station. As shown at 1101, the UE 1102 may transmit an indication of support for one or more UE capabilities associated with simultaneous configuration of both L3 and L1 UE-to-UE CLI measurement resources.

In some aspects, the UE may indicate the maximum number of resources that the UE supports, e.g., in UE capability signalling 1101. Using the information received from the UE 1102, the network node 1104 may configure measurement resources, e.g., at 1106 and 1116, based on the capabilities supported by the UE. For example, the network node 1104 may configure the UE 1102 with both L1 and L3 inter-UE CLI measurement resources, e.g., such that both configurations are configured for or active for the UE at the same time. In some aspects, both the L1 and L3 configuration can be received after the UE 1102 indicates the support for the UE capability, e.g., as shown for 1106 and 1116. In some aspects, the UE 1102 may receive one type of inter-UE CLI measurement configuration (e.g., either 1106 or 1116) prior to indicating the support for the UE capability, at 1106. Then, after indicating support for simultaneous configuration for L1 and L3 inter-UE CLI measurement resources, the UE 1102 may receive the second type of inter-UE CLI measurement configuration.

The network node 1104 may configure a number of CLI measurement resources based on the number of resources supported by the UE. For example, if supported, the UE 1102 may indicate at 1101 the maximum number of total configured UE-to-UE CLI measurement resources per CC supported by the UE. If supported, the UE 1102 may indicate, at 1101, the maximum number of total configured UE-to-UE CLI measurement resources per BWP supported by the UE. If supported, the UE 1102 may indicate, at 1101, the maximum number of total configured UE-to-UE CLI measurement resources cross CCs supported by the UE. If supported, the UE 1102 may indicate, at 1101, the maximum number of total configured UE-to-UE CLI measurement resources supported by the UE in a slot.

In the capability information, the maximum number of total configured UE-to-UE CLI measurement resources may include both configured L1 and L3 UE-to-UE CLI measurement resources. For example, the total number is shared between configured L1 and L3 UE-to-UE CLI measurement resources. The CLI measurement resources may include CLI-RSSI resources or SRS-RSRP resources, for example.

When considering the amount of L1 UE-to-UE CLI measurement CLI-RSSI resources, both type #1 and type #2 UE-to-UE CLI measurement resources may be considered. For frequency resource allocation of a CLI-RSSI measurement resource, a type #1 CLI-RSSI measurement resource is configured within a DL subband or a UL subband, for example. A type #2 CLI-RSSI measurement resource is configured across multiple (e.g., two) DL subbands.

As shown at 1108, the UE measures inter-UE CLI based on both L3 CLI measurement resources (e.g., configured at 1106) and the L1 CLI measurement resources (e.g., configured at 1116). The UE may measure CLI based on downlink signals 1103 for the UE 1111 and/or uplink signals 1105 transmitted by the UE 1111. The UE may transmit one or more CLI reports based on the L1 and/or L3 CLI measurements, as shown at 1110. The network node 1104 may then apply or coordinate CLI mitigation, at 1112, in response to the CLI report. In some aspects, the UE 1102 may transmit an L1 CLI measurement report or an L3 CLI measurement report. In some aspects, the UE 1102 may transmit an L1 CLI measurement report (e.g., based on a report configuration from 1116) and an L3 CLI measurement report (e.g., based on a report configuration from 1106). In some aspects, the UE 1102 may transmit a CLI report for one type of UE-to-UE CLI measurement that includes measurement information based on measurements of another type of UE-to-UE CLI measurement resource. For example, when reporting an L1 UE-to-UE CLI measurement report, e.g., based on a CSI framework, the L1 CLI report can refer to configured L3 UE-to-UE CLI measurement resources. By including measurements of the L3 CLI measurement resources when transmitting an L1 CLI measurement report, the UE is able to more quickly provide reporting for the configured L3 measurement resources.

Without simultaneous L1 and L3 CLI measurement, a CU receives the L3 UE-to-UE CLI measurement reporting, whereas a DU receives the L1 UE-to-UE CLI measurement reporting. In an example, where the UE (e.g., 1102 or 1112) transmits an L1 CLI measurement report that includes measurements based on L3 inter-UE CLI measurement resources, once the DU receives the L1 CLI reporting based, at least in part, on L3 CLI measurement resources, the DU can signal the CLI measurement report information to the CU, e.g., over F1AP backhaul signaling. FIG. 11B illustrates example aspects of a communication flow 1150 in which the UE 1112 (which may correspond to the UE 1102) transmits an L1 inter-UE CLI measurement report that is based, at least in part, on measurement of L3 inter-UE CLI measurement resources, at 1118. Then, at 1120, the DU 1114 forwards the L3 CLI measurement information from the report (e.g., 1118) to the CU 1116.

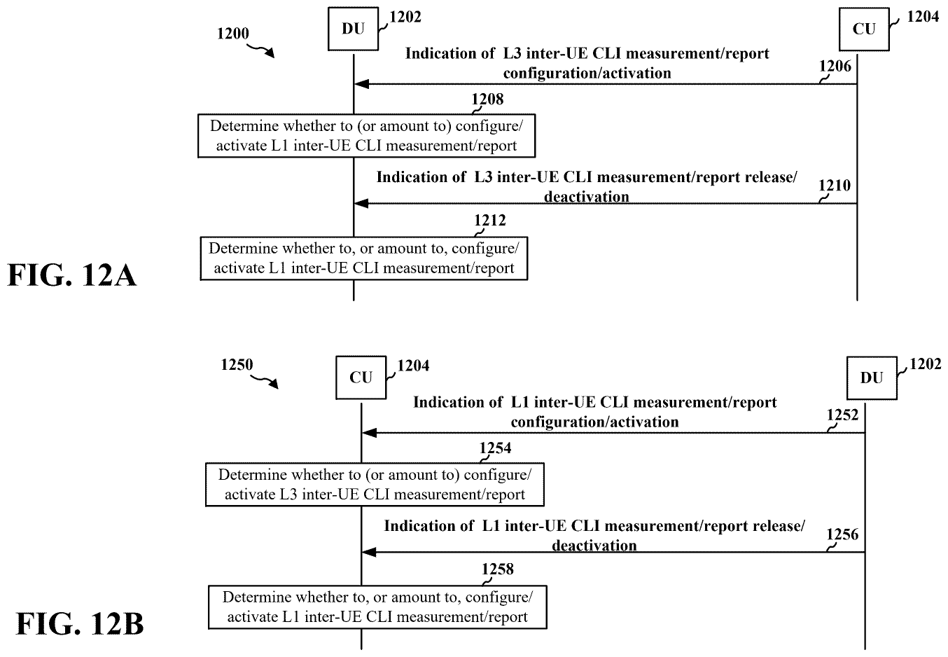

Similar to the exchange of information discussed in connection with FIG. 10A and FIG. 10B, in some aspects, a CU and DU may exchange information about L3 and L1 CLI measurement/report configurations to better coordinate configurations for the UE. As an example, a CU 1204 can signal the configuration of L3 UE-to-UE CLI measurement resources to a DU 1202, as shown at 1206, so that DU 1202 can decide whether or not to configure L1 UE-to-UE CLI measurement resources, at 1208. The signal may be over F1AP backhaul signaling, for example. Similarly, when a L3 inter-UE CLI measurement or report configuration are released or deactivated, the communication flow 1200 in FIG. 12A further shows that the CU 1204 may send further information to the DU, 1202, at 1210. The DU may make another determination, e.g., an updated determination, about whether to configure L1 inter-UE CLI measurement or report resources, at 1212. For example, the DU may use the information received from the CU 1204 and a UE capability (e.g., for a maximum number of inter-UE CLI measurement resources) to consider whether the UE supports additional resources beyond those configured by the CU 1204.

As shown at 1252 in the communication flow 1250 in FIG. 12B, the DU 1202 can signal the configuration of L1 UE-to-UE CLI measurement resources to the CU 1204, so that CU can decide, at 1254, whether to configure L3 UE-to-UE CLI measurement resources. Similarly, when an L1 inter-UE CLI measurement or report configuration is released or deactivated, the communication flow 1250 further shows that the DU 1202 may send further information to the CU 1204, at 1256. The CU 1204 may make another determination, e.g., an updated determination, about whether to configure L3 inter-UE CLI measurement or report resources, at 1258. For example, the CU 1204 may use the information received from the DU 1202 and a UE capability (e.g., for a maximum number of inter-UE CLI measurement resources) to consider whether the UE supports additional resources beyond those configured by the DU 1202. The signal may be over F1AP backhaul signaling.

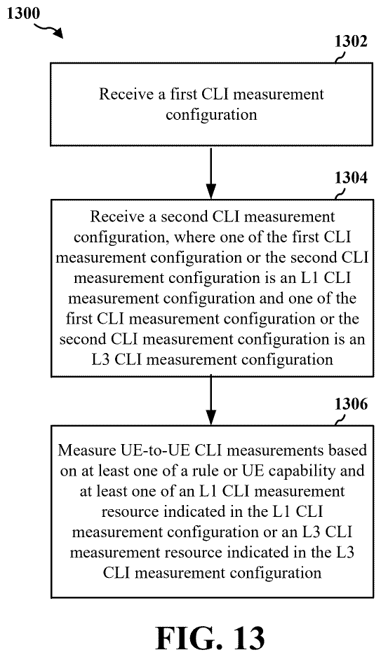

FIG. 13 is a flowchart 1300 of a method of wireless communication. The method may be performed by a UE (e.g., the UE 104, 350, 504, 506, 622, 624, 626, 628, 702, 802, 902, 1102, 1112; the apparatus 1504). The method enables a UE to be configured with one or more types of inter-UE CLI measurement resources/reports, e.g., based on one or more of a rule or UE capability. Some aspects provide for reduced latency in changing between an L1 and L3 inter-UE CLI measurement resources. Some aspects provide for simultaneous configuration for L1 and L3 inter-UE CLI measurement resources, which can reduce latency for the UE to provide CLI measurement information to the network, which enables the network to more quickly act to improve communication with the UE.

At 1302, the UE receives a first CLI measurement configuration. The reception may be performed, e.g., by one or more of the CLI measurement component 198, the transceiver 1522, and/or the antenna 1580. FIGS. 7, 8, 9, and 11A illustrate various example aspects of a UE receiving a configuration for CLI measurement and/or reporting. In some aspects, the configuration may configure one or more resources for CLI measurement. The resources may be periodic, semi-persistent, or aperiodic. Examples of CLI measurement resources are described, e.g., in connection with FIGS. 7, 8, 9, and 11A.

At 1304, the UE receives a second CLI measurement configuration, where one of the first CLI measurement configuration or the second CLI measurement configuration is an L1 CLI measurement configuration and one of the first CLI measurement configuration or the second CLI measurement configuration is an L3 CLI measurement configuration. The reception may be performed, e.g., by one or more of the CLI measurement component 198, the transceiver 1522, and/or the antenna 1580. FIGS. 7, 8, 9, and 11A illustrate various example aspects of a UE receiving a configuration for CLI measurement and/or reporting. In some aspects, the configuration may configure one or more resources for CLI measurement. The resources may be periodic, semi-persistent, or aperiodic. Examples of CLI measurement resources are described, e.g., in connection with FIGS. 7, 8, 9, and 11A.

At 1306, the UE measures UE-to-UE CLI measurements based on at least one of a rule or UE capability and at least one of an L1 CLI measurement resource indicated in the L1 CLI measurement configuration or an L3 CLI measurement resource indicated in the L3 CLI measurement configuration. The measurement may be performed, e.g., by one or more of the CLI measurement component 198, the transceiver 1522, and/or the antenna 1580. FIGS. 7, 8, 9, and 11A illustrate various example aspects of a UE performing CLI measurements, e.g., based on a single type of inter-UE CLI measurement resource or based on both L1 and L3 inter-UE CLI measurement resources.

In some aspects, the UE may further receive a release or a deactivation of the first CLI measurement configuration prior to or in connection with an activation of the second CLI measurement configuration. For example, based on the rule, the UE may not expect to be simultaneously configured with both the L1 CLI measurement configuration and the L3 CLI measurement configuration. In some aspects, the deactivation of the first CLI measurement configuration may be comprised in at least one of a medium access control-control element (MAC-CE) or a non-scheduling downlink control information (DCI). In some aspects, the activation of the second CLI measurement configuration in the MAC-CE or the non-scheduling DCI deactivates the first CLI measurement configuration. In some aspects, based on the rule, the first CLI measurement configuration may be released based on reception of the second CLI measurement configuration.

In some aspects, based on the rule, the UE is not to be simultaneously configured with both the L1 CLI measurement configuration and the L3 CLI measurement configuration. In some aspects, based on the rule, the UE is not to be configured with both the L1 CLI measurement configuration and the L3 CLI measurement configuration in a slot.

In some aspects, based on the UE capability, the UE-to-UE CLI measurements may be measured based on the at least one of the L1 CLI measurement resource indicated in the L1 CLI measurement configuration or the L3 CLI measurement resource indicated in the L3 CLI measurement configuration. In some aspects, the UE may support a capability for simultaneous configuration with both L1 and L3 CLI measurement resources (e.g., configured L1 and L3 CLI measurement resources in a same slot). In some aspects, the UE may further transmit an indication of support of the UE capability for simultaneous configuration with both the L1 CLI measurement configuration and the L3 CLI measurement configuration. The indication of support for the UE capability may indicate support for at least one of: a first maximum number of configured UE to UE CLI measurement resources per component carrier (CC), a second maximum number of configured UE to UE CLI measurement resources per bandwidth part (BWP), a third maximum number of configured UE to UE CLI measurement resources across multiple CCs, or a fourth maximum number of configured UE to UE CLI measurement resources in a period of time. In some aspects, a maximum number of configured UE-to-UE CLI measurement resources includes L1 and L3 UE-to-UE CLI measurement resources. In some aspects, the maximum number of configured UE-to-UE CLI measurement resources includes different types of L1 and L3 UE-to-UE CLI measurement resources, e.g., type #1 L1 UE-to-UE CLI measurement resources that are configured within a downlink subband or an uplink subband and type #2 L1 UE-to-UE CLI measurement resources that are configured across multiple downlink subbands.

In some aspects, the UE may transmit a report based on the UE-to-UE CLI measurements in the L1 CLI measurement resource or the L3 CLI measurement resource. In some aspects, the UE may transmit a report based on the UE-to-UE CLI measurements in the L1 CLI measurement resource and the L3 CLI measurement resource. In some aspects, the report may be based on an L1 CLI report configuration and includes measurement information for one or more L3 CLI measurement resources.

The method may further include any of the aspects described in connection with any of FIGS. 4-12B, for example.

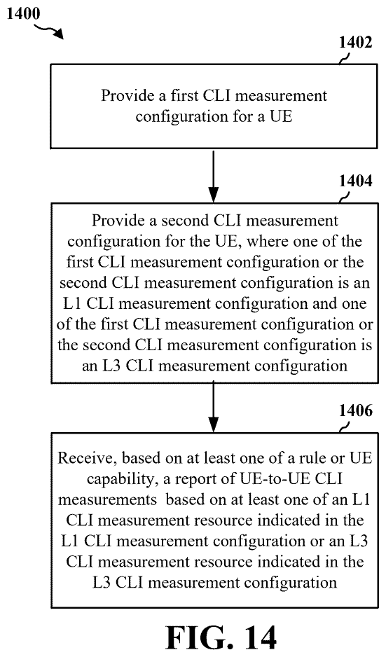

FIG. 14 is a flowchart 1400 of a method of wireless communication. The method may be performed by a base station, e.g., in aggregation or by one or more components of a disaggregated base station (e.g., the base station 102, 310, 502, 606, 608; the CU 110, 1004, 1116, 1204; the DU 130, 1006, 1114, 1202; the RU 140; the network node 704, 804, 904, the network entity 1602). The method enables the network node to configure one or more types of inter-UE CLI measurement resources/reports, e.g., based on one or more of a rule or UE capability. Some aspects provide for reduced latency in changing between an L1 and L3 inter-UE CLI measurement resources. Some aspects provide for simultaneous configuration for L1 and L3 inter-UE CLI measurement resources, which can reduce latency for the UE to provide CLI measurement information to the network, which enables the network to more quickly act to improve communication with the UE.

At 1402, the network node provides a first CLI measurement configuration for a UE. The providing may be performed, e.g., by one or more of a CU, a DU, and/or an RU. In some aspects, the network node may transmit or otherwise send the configuration for the UE. In some aspects, the providing may be performed, e.g., by the CLI measurement configuration component 199, the transceiver 1646, and/or the antenna 1680. FIGS. 7, 8, 9, and 11A illustrate various example aspects of a network node providing, e.g., sending or transmitting, a configuration for CLI measurement and/or reporting. In some aspects, the configuration may configure one or more resources for CLI measurement. The resources may be periodic, semi-persistent, or aperiodic. Examples of CLI measurement resources are described, e.g., in connection with FIGS. 7, 8, 9, and 11A.

At 1404, the network node provides a second CLI measurement configuration for the UE, wherein one of the first CLI measurement configuration or the second CLI measurement configuration is an L1 CLI measurement configuration and one of the first CLI measurement configuration or the second CLI measurement configuration is an L3 CLI measurement configuration. The providing may be performed, e.g., by one or more of a CU, a DU, and/or an RU. In some aspects, the network node may transmit or otherwise send the configuration for the UE. In some aspects, the providing may be performed, e.g., by the CLI measurement configuration component 199, the transceiver 1646, and/or the antenna 1680. FIGS. 7, 8, 9, and 11A illustrate various example aspects of a network node providing, e.g., sending or transmitting, a configuration for CLI measurement and/or reporting. In some aspects, the configuration may configure one or more resources for CLI measurement. The resources may be periodic, semi-persistent, or aperiodic. Examples of CLI measurement resources are described, e.g., in connection with FIGS. 7, 8, 9, and 11A.

At 1406, the network node receives, based on at least one of a rule or UE capability, a report of UE-to-UE CLI measurements based on at least one of an L1 CLI measurement resource indicated in the L1 CLI measurement configuration or an L3 CLI measurement resource indicated in the L3 CLI measurement configuration. The reception may be performed, e.g., by one or more of a CU, a DU, and/or an RU. In some aspects, the reception may be performed, e.g., by the CLI measurement configuration component 199, the transceiver 1646, and/or the antenna 1680. FIGS. 7, 8, 9, and 11A illustrate various example aspects of a network node receive a report of CLI measurements.

In some aspects, the rule may indicate that a UE is not to be simultaneously configured with both the L1 CLI measurement configuration and the L3 CLI measurement configuration. In some aspects, the rule may indicate that a UE is not to be configured with both the L1 CLI measurement configuration and the L3 CLI measurement configuration in a slot.

In some aspects, the network node may further release or deactivate the first CLI measurement configuration prior to or in connection with an activation of the second CLI measurement configuration, wherein a deactivation of the first CLI measurement configuration is comprised in at least one of a medium access control-control element (MAC-CE) or a non-scheduling downlink control information (DCI). In some aspects, the activation of the second CLI measurement configuration in the MAC-CE or the non-scheduling DCI deactivates the first CLI measurement configuration.

In some aspects, e.g., based on the rule, the first CLI measurement configuration may be released based on the second CLI measurement configuration. In some aspects, e.g., based on the rule, the network node may avoid simultaneously configuring the UE with both the L1 CLI measurement configuration and the L3 CLI measurement configuration.

In some aspects, the network node is a first network node that configures the first CLI measurement configuration, and the network node may be further configured to send, via F1-AP backhaul signaling to a second network node, an indication about a release of the first CLI measurement configuration, wherein the second CLI measurement configuration is from the second network node.

In some aspects, the network node is a second network node that configures the second CLI measurement configuration, and the network node may be further configured to receive, via F1-AP backhaul signaling from a first network node, an indication about a release of the first CLI measurement configuration, wherein the second CLI measurement configuration is configured after reception of the indication.

In some aspects, the network node is a distributed unit (DU), and receives, via F1-AP backhaul signaling from a centralized unit (CU), an indication of an L3 CLI measurement configuration for the UE, and determines not to configure an L1 CLI measurement configuration for the UE based on the indication from the CU. In some aspects, the network node is a centralized unit (CU) that receives, via F1-AP backhaul signaling from a distributed unit (DU), an indication of an L1 CLI measurement configuration for the UE and determines not to configure an L3 CLI measurement configuration for the UE based on the indication from the DU.

In some aspects, based on the UE capability, the report includes measurements based on the at least one of the L1 CLI measurement resource indicated in the L1 CLI measurement configuration or the L3 CLI measurement resource indicated in the L3 CLI measurement configuration. In some aspects, the network node is further configured to receive an indication of support for the UE capability for simultaneous configuration with both the L1 CLI measurement configuration and the L3 CLI measurement configuration, where the second CLI measurement configuration is configured based on the support of the UE capability. In some aspects, a maximum number of configured UE-to-UE CLI measurement resources includes L1 and L3 UE-to-UE CLI measurement resources, and where the indication of support for the UE capability indicates support for at least one of: a first maximum number of configured UE to UE CLI measurement resources per component carrier (CC), a second maximum number of configured UE to UE CLI measurement resources per bandwidth part (BWP), a third maximum number of configured UE to UE CLI measurement resources across multiple CCs, or a fourth maximum number of configured UE to UE CLI measurement resources in a period of time. In some aspects, a maximum number of configured UE-to-UE CLI measurement resources may include different types of L1 and L3 UE-to-UE CLI measurement resources, e.g., type #1 L1 UE-to-UE CLI measurement resources that are configured within a downlink subband or an uplink subband and type #2 L1 UE-to-UE CLI measurement resources that are configured across multiple downlink subbands. In some aspects, the report is based on an L1 CLI report configuration and includes measurement information for one or more L3 CLI measurement resources. In some aspects, the network node further provides the measurement information for the one or more L3 CLI measurement resources from a distributed unit (DU) to a CU via backhaul signaling.

In some aspects, the network node indicates the first CLI measurement configuration for the UE to a second network node. In some aspects, the network further receives an indication of the first CLI measurement configuration for the UE from a second network node over backhaul signaling, wherein a determination whether to send the second CLI measurement configuration for the UE based, at least in part, on the indication.

The method may further include any of the aspects described in connection with any of FIGS. 4-12B, for example.

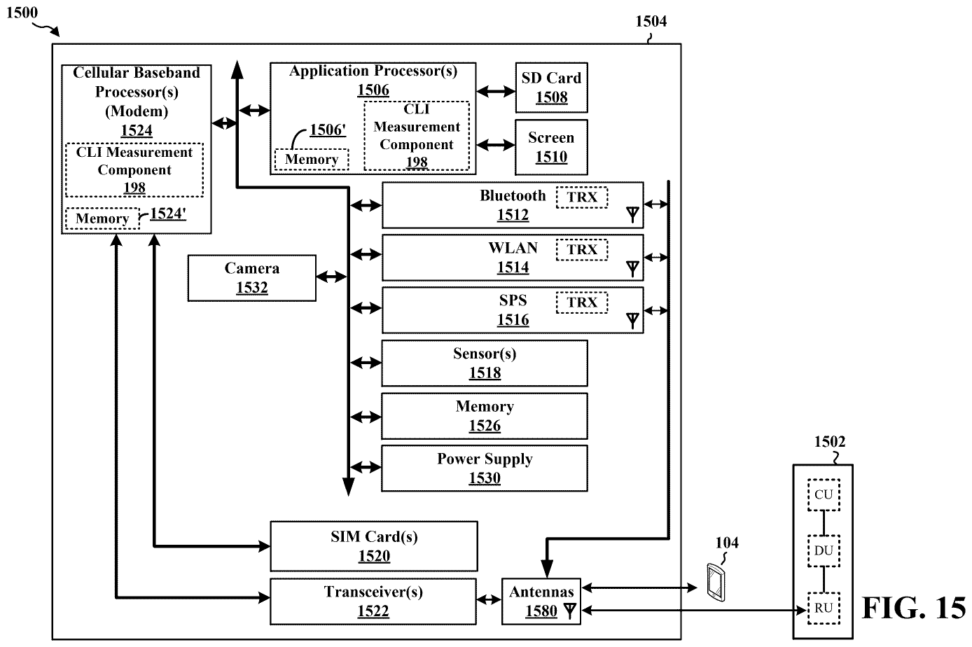

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the CLI measurement component 198 may be configured to receive a first cross-link interference (CLI) measurement configuration; receive a second CLI measurement configuration, wherein one of the first CLI measurement configuration or the second CLI measurement configuration is a layer 1 (L1) CLI measurement configuration and one of the first CLI measurement configuration or the second CLI measurement configuration is a layer 3 (L3) CLI measurement configuration; and measure UE-to-UE CLI measurements based on at least one of a rule or UE capability and at least one of an L1 CLI measurement resource indicated in the L1 CLI measurement configuration or an L3 CLI measurement resource indicated in the L3 CLI measurement configuration. The CLI measurement component 198 and/or the apparatus 1504 may be further configured to perform any of the aspects described in connection with the flowchart in FIG. 13 and/or performed by the UE in any of FIGS. 7, 8, 9, 11A and/or 11B. The component 198 may be within the cellular baseband processor(s) 1524, the application processor(s) 1506, or both the cellular baseband processor(s) 1524 and the application processor(s) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving a first cross-link interference (CLI) measurement configuration; means for receiving a second CLI measurement configuration, wherein one of the first CLI measurement configuration or the second CLI measurement configuration is a layer 1 (L1) CLI measurement configuration and one of the first CLI measurement configuration or the second CLI measurement configuration is a layer 3 (L3) CLI measurement configuration; and means for measuring UE-to-UE CLI measurements based on at least one of a rule or UE capability and at least one of an L1 CLI measurement resource indicated in the L1 CLI measurement configuration or an L3 CLI measurement resource indicated in the L3 CLI measurement configuration. The apparatus 1504 may further include means for performing any of the aspects described in connection with the flowchart in FIG. 13 and/or performed by the UE in any of FIGS. 7, 8, 9, 11A and/or 11B. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

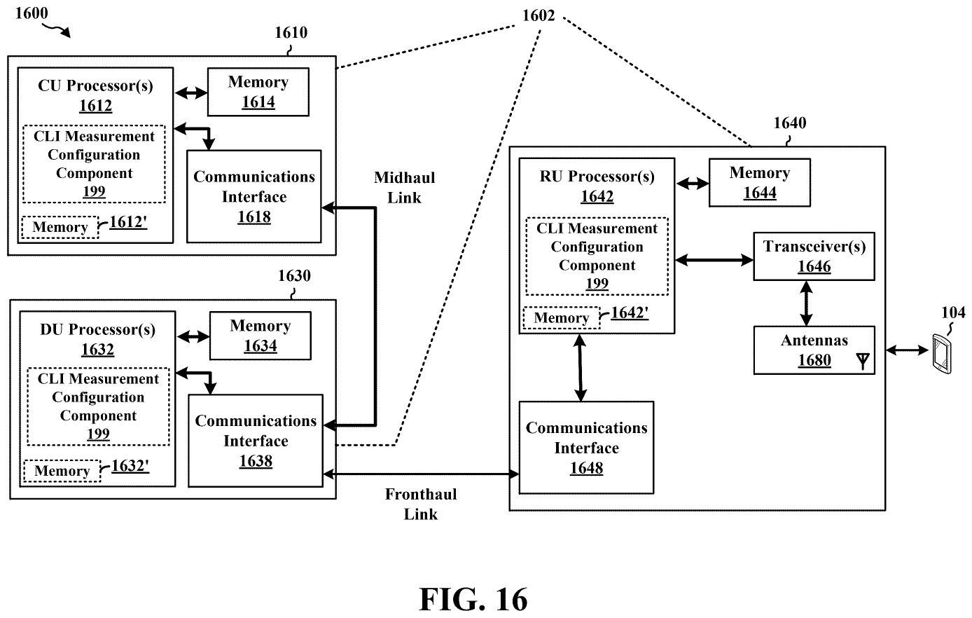

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide a first cross-link interference (CLI) measurement configuration for a user equipment (UE); provide a second CLI measurement configuration for the UE, wherein one of the first CLI measurement configuration or the second CLI measurement configuration is a layer 1 (L1) CLI measurement configuration and one of the first CLI measurement configuration or the second CLI measurement configuration is a layer 3 (L3) CLI measurement configuration; and receive a report of UE-to-UE CLI measurements based on at least one of a rule or UE capability and at least one of an L1 CLI measurement resource indicated in the L1 CLI measurement configuration or an L3 CLI measurement resource indicated in the L3 CLI measurement configuration. The CLI measurement configuration component 199 and/or the network entity 1602 may be further configured to perform any of the aspects described in connection with the flowchart in FIG. 14 and/or performed by the network node, DU, or CU in any of FIG. 7, 8, 9, 10A, 10B, 11A, 11B, 12A, or 12B. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for providing a first cross-link interference (CLI) measurement configuration for a user equipment (UE); means for providing a second CLI measurement configuration for the UE, wherein one of the first CLI measurement configuration or the second CLI measurement configuration is a layer 1 (L1) CLI measurement configuration and one of the first CLI measurement configuration or the second CLI measurement configuration is a layer 3 (L3) CLI measurement configuration; and means for receiving a report of UE-to-UE CLI measurements based on at least one of a rule or UE capability and at least one of an L1 CLI measurement resource indicated in the L1 CLI measurement configuration or an L3 CLI measurement resource indicated in the L3 CLI measurement configuration. The network entity 1602 may further include means for performing any of the aspects described in connection with the flowchart in FIG. 14 and/or performed by the network node, DU, or CU in any of FIG. 7, 8, 9, 10A, 10B, 11A, 11B, 12A, or 12B. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a user equipment (UE), comprising: receiving a first cross-link interference (CLI) measurement configuration; receiving a second CLI measurement configuration, wherein one of the first CLI measurement configuration or the second CLI measurement configuration is a layer 1 (L1) CLI measurement configuration and one of the first CLI measurement configuration or the second CLI measurement configuration is a layer 3 (L3) CLI measurement configuration; and measuring UE-to-UE CLI measurements based on at least one of a rule or UE capability and at least one of an L1 CLI measurement resource indicated in the L1 CLI measurement configuration or an L3 CLI measurement resource indicated in the L3 CLI measurement configuration.

In aspect 2, the method further includes receiving a release or a deactivation of the first CLI measurement configuration prior to or in connection with an activation of the second CLI measurement configuration.

In aspect 3, the method of aspect 1 or aspect 2 further includes that, based on the rule, the UE is not to be simultaneously configured with both the L1 CLI measurement configuration and the L3 CLI measurement configuration.

In aspect 4, the method of any of aspects 1-3 further includes that, based on the rule, the UE is not to be configured with both the L1 CLI measurement configuration and the L3 CLI measurement configuration in a slot.

In aspect 5, the method of any of aspects 1-4 further includes that the deactivation of the first CLI measurement configuration is comprised in at least one of a medium access control-control element (MAC-CE) or a non-scheduling downlink control information (DCI).

In aspect 6, the method of aspect 5 further includes that the activation of the second CLI measurement configuration in the MAC-CE or the non-scheduling DCI deactivates the first CLI measurement configuration.

In aspect 7, the method of any of aspects 1, 3, or 4 further includes that, based on the rule, the first CLI measurement configuration is released based on reception of the second CLI measurement configuration.

In aspect 8, the method of any of aspect 1 further includes that, based on the UE capability, the UE-to-UE CLI measurements are measured based on the at least one of the L1 CLI measurement resource indicated in the L1 CLI measurement configuration or the L3 CLI measurement resource indicated in the L3 CLI measurement configuration.

In aspect 9, the method of aspect 8 further includes transmitting an indication of support of the UE capability for simultaneous configuration with both the L1 CLI measurement configuration and the L3 CLI measurement configuration.

In aspect 10, the method of any of aspect 8 or 9 further includes that, the indication of support for the UE capability indicates support for at least one of: a first maximum number of configured UE to UE CLI measurement resources per component carrier (CC), a second maximum number of configured UE to UE CLI measurement resources per bandwidth part (BWP), a third maximum number of configured UE to UE CLI measurement resources across multiple CCs, or a fourth maximum number of configured UE to UE CLI measurement resources in a period of time.

In aspect 11, the method of aspect 10 further includes that a maximum number of configured UE-to-UE CLI measurement resources includes L1 and L3 UE-to-UE CLI measurement resources.

In aspect 12, the method of aspect 10 or 11 further includes that a maximum number of configured UE-to-UE CLI measurement resources includes different types of L1 and L3 UE-to-UE CLI measurement resources, wherein the different types include type 1 L1 UE-to-UE CLI measurement resources that are configured within a downlink subband or an uplink subband and type 2 L1 UE-to-UE CLI measurement resources that are configured across multiple downlink subbands.

In aspect 13, the method of any of aspect 8-12 further includes transmitting a report based on the UE-to-UE CLI measurements in the L1 CLI measurement resource or the L3 CLI measurement resource.

In aspect 14, the method of any of aspect 8-12 further includes transmitting a report based on the UE-to-UE CLI measurements in the L1 CLI measurement resource and the L3 CLI measurement resource.

In aspect 15, the method of any of aspect 13 or 14 further includes that the report is based on an L1 CLI report configuration and includes measurement information for one or more L3 CLI measurement resources.

Aspect 16 is an apparatus for wireless communication at a UE, comprising: at least one memory; and at least one processor coupled to the at least one memory, the at least one processor is configured to perform the method of any of aspects 1 to 15.

Aspect 17 is an apparatus for wireless communication at a UE, comprising means for performing each step in the method of any of aspects 1 to 15.

Aspect 18 is the apparatus of any of aspects 16 or 17, further comprising at least one transceiver configured to receive or to transmit in association with the method of any of aspects 1 to 15.

Aspect 19 is a computer-readable medium storing computer executable code at a UE, the code when executed by at least one processor causes the at least one processor to perform the method of any of aspects 1 to 15.

Aspect 20 is a method of wireless communication at a network node, comprising: providing a first cross-link interference (CLI) measurement configuration for a user equipment (UE); providing a second CLI measurement configuration for the UE, wherein one of the first CLI measurement configuration or the second CLI measurement configuration is a layer 1 (L1) CLI measurement configuration and one of the first CLI measurement configuration or the second CLI measurement configuration is a layer 3 (L3) CLI measurement configuration; and receiving, based on at least one of a rule or UE capability, a report of UE-to-UE CLI measurements based on at least one of an L1 CLI measurement resource indicated in the L1 CLI measurement configuration or an L3 CLI measurement resource indicated in the L3 CLI measurement configuration.

In aspect 21, the method of aspect 20 further includes releasing or deactivating the first CLI measurement configuration prior to or in connection with an activation of the second CLI measurement configuration.

In aspect 22, the method of any of aspects 20-21 further includes that a deactivation of the first CLI measurement configuration is comprised in at least one of a medium access control-control element (MAC-CE) or a non-scheduling downlink control information (DCI).

In aspect 23, the method of any of aspects 20-22 further includes that an activation of a second CLI measurement configuration in the medium access control-control element (MAC-CE) or a non-scheduling downlink control information (DCI) deactivates the first CLI measurement configuration.

In aspect 24, the method of aspect 20 further includes that, based on the rule, the first CLI measurement configuration is released based on the second CLI measurement configuration.

In aspect 25, the method of any of aspects 20-24 further includes that, based on the rule, the network node avoids simultaneously configuring the UE with both the L1 CLI measurement configuration and the L3 CLI measurement configuration.

In aspect 26, the method of any of aspects 20-25 further includes that the network node is a first network node that configures the first CLI measurement configuration, the method further comprising: sending, via F1-AP backhaul signaling to a second network node, an indication about a release of the first CLI measurement configuration, wherein the second CLI measurement configuration is from the second network node.

In aspect 27, the method of any of aspects 20-25 further includes that the network node is a second network node that configures the second CLI measurement configuration, the method further comprising: receiving, via F1-AP backhaul signaling from a first network node, an indication about a release of the first CLI measurement configuration, wherein the second CLI measurement configuration is configured after reception of the indication.

In aspect 28, the method of any of aspects 20-25 further includes that the network node is a distributed unit (DU), the method further comprising: receiving, via F1-AP backhaul signaling from a centralized unit (CU), an indication of an L3 CLI measurement configuration for the UE; and determining not to configure an L1 CLI measurement configuration for the UE based on the indication from the CU.

In aspect 29, the method of any of aspects 20-25 further includes the network node is a centralized unit (CU), the method further comprising: receiving, via F1-AP backhaul signaling from a distributed unit (DU), an indication of an L1 CLI measurement configuration for the UE; and determining not to configure an L3 CLI measurement configuration for the UE based on the indication from the DU.

In aspect 30, the method of aspect 20, further includes that, based on the UE capability, the report includes measurements based on the at least one of the L1 CLI measurement resource indicated in the L1 CLI measurement configuration or the L3 CLI measurement resource indicated in the L3 CLI measurement configuration.

In aspect 31, the method of aspect 30 further includes receiving an indication of support for the UE capability for simultaneous configuration with both the L1 CLI measurement configuration and the L3 CLI measurement configuration, wherein the second CLI measurement configuration is configured based on the support of the UE capability.

In aspect 32, the method of any of aspects 30-31 further includes that a maximum number of configured UE-to-UE CLI measurement resources includes L1 and L3 UE-to-UE CLI measurement resources.

In aspect 33, the method of any of aspects 30-32 further includes that the indication of support for the UE capability indicates support for at least one of: a first maximum number of configured UE to UE CLI measurement resources per component carrier (CC), a second maximum number of configured UE to UE CLI measurement resources per bandwidth part (BWP), a third maximum number of configured UE to UE CLI measurement resources across multiple CCs, or a fourth maximum number of configured UE to UE CLI measurement resources in a period of time.

In aspect 34, the method of any of aspects 30-33 further includes that maximum number of configured UE-to-UE CLI measurement resources includes different types of the L1 and L3 UE-to-UE CLI measurement resources.

In aspect 35, the method of aspect 34 further includes that the different types include type 1 L1 UE-to-UE CLI measurement resources that are configured within a downlink subband or an uplink subband and type 2 L1 UE-to-UE CLI measurement resources that are configured across multiple downlink subbands.

In aspect 36, the method of any of aspects 20-35, wherein the report is based on the UE-to-UE CLI measurements in the L1 CLI measurement resource or the L3 CLI measurement resource. In aspect 37, the method of any of aspects 20 and 30-35, wherein the report is based on the UE-to-UE CLI measurements in the L1 CLI measurement resource and the L3 CLI measurement resource. In aspect 38, the method of any of aspects 20 and 30-35 and 37 further includes that the report is based on an L1 CLI report configuration and includes measurement information for one or more L3 CLI measurement resources.

In Aspect 39, the method of aspect 37 or 38 further includes providing the measurement information for the one or more L3 CLI measurement resources from a distributed unit (DU) to a CU via backhaul signaling.

In aspect 40, the method of any of aspects 20-39 further includes indicating the first CLI measurement configuration for the UE to a second network node.

In aspect 41, the method of any of aspects 20-39 further includes receiving an indication of the first CLI measurement configuration for the UE from the second network node over backhaul signaling, wherein a determination of whether to send the second CLI measurement configuration for the UE is based, at least in part, on the indication.

Aspect 42 is an apparatus for wireless communication at a network node, comprising: at least one memory; and at least one processor coupled to the at least one memory, the at least one processor is configured to perform the method of any of aspects 20 to 41.

Aspect 43 is an apparatus for wireless communication at a network node, comprising means for performing each step in the method of any of aspects 20 to 41.

Aspect 44 is the apparatus of any of aspects 42 to 43, further comprising a transceiver configured to receive or to transmit in association with the method of any of aspects 20 to 41.

Aspect 45 is a computer-readable medium storing computer executable code at a network node, the code when executed by at least one processor causes the at least one processor to perform the method of any of aspects 20 to 41.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive a first cross-link interference (CLI) measurement configuration;
receive a second CLI measurement configuration, wherein one of the first CLI measurement configuration or the second CLI measurement configuration is a layer 1 (L1) CLI measurement configuration and one of the first CLI measurement configuration or the second CLI measurement configuration is a layer 3 (L3) CLI measurement configuration; and
measure UE-to-UE CLI measurements based on at least one of a rule or UE capability and at least one of an L1 CLI measurement resource indicated in the L1 CLI measurement configuration or an L3 CLI measurement resource indicated in the L3 CLI measurement configuration.

2. The apparatus of claim 1, wherein the at least one processor is further configured to:
receive a release or a deactivation of the first CLI measurement configuration prior to or in connection with an activation of the second CLI measurement configuration.

3. The apparatus of claim 2, wherein, based on the rule, the UE is not to be simultaneously configured with both the L1 CLI measurement configuration and the L3 CLI measurement configuration.

4. The apparatus of claim 2, wherein, based on the rule, the UE is not to be configured with both the L1 CLI measurement configuration and the L3 CLI measurement configuration in a slot.

5. The apparatus of claim 2, wherein the deactivation of the first CLI measurement configuration is comprised in at least one of a medium access control-control element (MAC-CE) or a non-scheduling downlink control information (DCI).

6. The apparatus of claim 5, wherein the activation of the second CLI measurement configuration in the MAC-CE or the non-scheduling DCI deactivates the first CLI measurement configuration.

7. The apparatus of claim 1, wherein, based on the rule, the first CLI measurement configuration is released based on reception of the second CLI measurement configuration.

8. The apparatus of claim 1, wherein, based on the UE capability, the UE-to-UE CLI measurements are measured based on the at least one of the L1 CLI measurement resource indicated in the L1 CLI measurement configuration or the L3 CLI measurement resource indicated in the L3 CLI measurement configuration.

9. The apparatus of claim 8, wherein the at least one processor is further configured to:
transmit an indication of support of the UE capability for simultaneous configuration with both the L1 CLI measurement configuration and the L3 CLI measurement configuration.

10. The apparatus of claim 9, wherein the indication of support for the UE capability indicates that the UE supports at least one of:
a first maximum number of configured UE to UE CLI measurement resources per component carrier (CC),
a second maximum number of configured UE to UE CLI measurement resources per bandwidth part (BWP),
a third maximum number of configured UE to UE CLI measurement resources across multiple CCs, or
a fourth maximum number of configured UE to UE CLI measurement resources in a period of time.

11. The apparatus of claim 10, wherein a maximum number of configured UE-to-UE CLI measurement resources includes L1 and L3 UE-to-UE CLI measurement resources.

12. The apparatus of claim 10, wherein a maximum number of configured UE-to-UE CLI measurement resources includes different types of L1 and L3 UE-to-UE CLI measurement resources, wherein the different types include type 1 L1 UE-to-UE CLI measurement resources that are configured within a downlink subband or an uplink subband and type 2 L1 UE-to-UE CLI measurement resources that are configured across multiple downlink subbands.

13. The apparatus of claim 1, wherein the at least one processor is further configured to:
transmit a report based on the UE-to-UE CLI measurements in the L1 CLI measurement resource or the L3 CLI measurement resource.

14. The apparatus of claim 1, further comprising a transceiver coupled to the at least one processor, wherein the at least one processor is further configured to:
transmit, via the transceiver, a report based on the UE-to-UE CLI measurements in the L1 CLI measurement resource and the L3 CLI measurement resource.

15. The apparatus of claim 14, wherein the report is based on an L1 CLI report configuration and includes measurement information for one or more L3 CLI measurement resources.

16. An apparatus for wireless communication at a network node, comprising:
at least one memory; and
at least one processor coupled to the at least one memory and, based at least in part on information stored in the at least one memory, the at least one processor is configured to:
provide a first cross-link interference (CLI) measurement configuration for a user equipment (UE);
provide a second CLI measurement configuration for the UE, wherein one of the first CLI measurement configuration or the second CLI measurement configuration is a layer 1 (L1) CLI measurement configuration and one of the first CLI measurement configuration or the second CLI measurement configuration is a layer 3 (L3) CLI measurement configuration; and
receive, based on at least one of a rule or UE capability, a report of UE-to-UE CLI measurements based on at least one of an L1 CLI measurement resource indicated in the L1 CLI measurement configuration or an L3 CLI measurement resource indicated in the L3 CLI measurement configuration.

17. The apparatus of claim 16, wherein the at least one processor is further configured to:
release or deactivate the first CLI measurement configuration prior to or in connection with an activation of the second CLI measurement configuration, wherein a deactivation of the first CLI measurement configuration is comprised in at least one of a medium access control-control element (MAC-CE) or a non-scheduling downlink control information (DCI).

18. The apparatus of claim 17, wherein the activation of the second CLI measurement configuration in the MAC-CE or the non-scheduling DCI deactivates the first CLI measurement configuration.

19. The apparatus of claim 16, wherein, based on the rule, the first CLI measurement configuration is released based on the second CLI measurement configuration.

20. The apparatus of claim 16, wherein, based on the rule, the network node avoids simultaneously configuring the UE with both the L1 CLI measurement configuration and the L3 CLI measurement configuration.

21. The apparatus of claim 16, wherein the network node is a first network node that configures the first CLI measurement configuration, wherein the at least one processor is further configured to:
send, via F1-AP backhaul signaling to a second network node, an indication about a release of the first CLI measurement configuration, wherein the second CLI measurement configuration is from the second network node.

22. The apparatus of claim 16, wherein the network node is a second network node that configures the second CLI measurement configuration, wherein the at least one processor is further configured to:
receive, via F1-AP backhaul signaling from a first network node, an indication about a release of the first CLI measurement configuration, wherein the second CLI measurement configuration is configured after reception of the indication.

23. The apparatus of claim 16, wherein the network node is a distributed unit (DU), wherein the at least one processor is further configured to:
receive, via F1-AP backhaul signaling from a centralized unit (CU), an indication of an L3 CLI measurement configuration for the UE; and
determine not to configure an L1 CLI measurement configuration for the UE based on the indication from the CU.

24. The apparatus of claim 16, wherein the network node is a centralized unit (CU), wherein the at least one processor is further configured to:
receive, via F1-AP backhaul signaling from a distributed unit (DU), an indication of an L1 CLI measurement configuration for the UE; and
determine not to configure an L3 CLI measurement configuration for the UE based on the indication from the DU.

25. The apparatus of claim 16, wherein, based on the UE capability, the report includes measurements based on the at least one of the L1 CLI measurement resource indicated in the L1 CLI measurement configuration or the L3 CLI measurement resource indicated in the L3 CLI measurement configuration.

26. The apparatus of claim 25, wherein the at least one processor is further configured to:
receive an indication of support for the UE capability for simultaneous configuration with both the L1 CLI measurement configuration and the L3 CLI measurement configuration, wherein the second CLI measurement configuration is configured based on the support of the UE capability, and wherein a maximum number of configured UE-to-UE CLI measurement resources includes L1 and L3 UE-to-UE CLI measurement resources, and wherein the indication of support for the UE capability indicates support for at least one of:
a first maximum number of configured UE to UE CLI measurement resources per component carrier (CC),
a second maximum number of configured UE to UE CLI measurement resources per bandwidth part (BWP),
a third maximum number of configured UE to UE CLI measurement resources across multiple CCs, or
a fourth maximum number of configured UE to UE CLI measurement resources in a period of time.

27. The apparatus of claim 26, wherein the maximum number of configured UE-to-UE CLI measurement resources includes different types of the L1 and L3 UE-to-UE CLI measurement resources, wherein the different types include type 1 L1 UE-to-UE CLI measurement resources that are configured within a downlink subband or an uplink subband and type 2 L1 UE-to-UE CLI measurement resources that are configured across multiple downlink subbands.

28. The apparatus of claim 16, wherein the report is based on an L1 CLI report configuration and includes measurement information for one or more L3 CLI measurement resources.

29. The apparatus of claim 28, wherein the at least one processor is further configured to:
provide the measurement information for the one or more L3 CLI measurement resources from a distributed unit (DU) to a CU via backhaul signaling.

30. The apparatus of claim 16, wherein the at least one processor is further configured to:
indicate the first CLI measurement configuration for the UE to a second network node; or
receive an indication of the first CLI measurement configuration for the UE from the second network node over backhaul signaling, wherein a determination whether to send the second CLI measurement configuration for the UE based, at least in part, on the indication.
